(19) United States
(12) Patent Application Publication
(10) Pub. No.: US 2013/0229953 A1
(43) Pub. Date: Sep. 5, 2013

(54) APPARATUS AND METHOD FOR INDICATING SYNCHRONIZATION SIGNALS IN A WIRELESS NETWORK

(71) Applicants: Young-Han Nam, Richardson, TX (US); Boon Loong Ng, Richardson, TX (US); Jianzhong Zhang, Plano, TX (US)

(72) Inventors: Young-Han Nam, Richardson, TX (US); Boon Loong Ng, Richardson, TX (US); Jianzhong Zhang, Plano, TX (US)

(73) Assignee: Samsung Electronics Co., Ltd., Suwon-si (KR)

(21) Appl. No.: 13/572,183

(22) Filed: Aug. 10, 2012

Related U.S. Application Data
(60) Provisional application No. 61/524,144, filed on Aug. 16, 2011.
(60) Provisional application No. 61/565,874, filed on Dec. 1, 2011.
(60) Provisional application No. 61/600,414, filed on Feb. 17, 2012.
(60) Provisional application No. 61/646,084, filed on May 11, 2012.

(51) Int. Cl. H04W 72/04

(52) U.S. Cl. CPC H04W 72/0426
USPC 370/280; 370/329; 370/281

(57) ABSTRACT

A base station in a heterogeneous network is configured to communicate with a plurality of base stations via a backhaul link and configured to communicate with a plurality of subscriber stations. The base station includes a transmit path configured to transmit data, reference signals, synchronization signals and control elements to at least one of the plurality of subscriber stations. The base station also includes processing circuitry configured to map primary synchronization signals (PSS) and secondary synchronization signals (SSS) onto each of a carrier of a first carrier type and a carrier of a second carrier type. The PSS and SSS on the second carrier type are mapped onto different time locations than in the first carrier type. In addition, the PSS/SSS are mapped onto consecutive resource elements (REs) on each of the carrier of the first type and the carrier of the second type.

### CROSS-REFERENCE TO RELATED APPLICATION(S) AND CLAIM OF PRIORITY

The present application is related to U.S. Provisional Patent Application No. 61/524,144, filed Aug. 16, 2011, entitled “SYNCHRONIZATION SIGNALS FOR WIRELESS COMMUNICATION SYSTEMS”, U.S. Provisional Patent Application No. 61/565,874, filed Dec. 1, 2011, entitled “SYNCHRONIZATION SIGNALS FOR WIRELESS COMMUNICATION SYSTEMS”, U.S. Provisional Patent Application No. 61/600,414, filed Feb. 17, 2012, entitled “SYNCHRONIZATION SIGNALS FOR WIRELESS COMMUNICATION SYSTEMS” and U.S. Provisional Patent Application No. 61/646,084, filed May 11, 2012, entitled SYNCHRONIZATION SIGNALS FOR WIRELESS COMMUNICATION SYSTEMS″. Provisional Patent Application Nos. 61/524,144, 61/565,874, 61/600,414 and 61/646,084 are assigned to the assignee of the present application and is hereby incorporated by reference into the present application as if fully set forth herein. The present application hereby claims priority under 35 U.S.C. §119(e) to U.S. Provisional Patent Application Nos. 61/524,144, 61/565,874, 61/600,414 and 61/646,084.

### TECHNICAL FIELD

The present application relates generally to wireless communications and, more specifically, to a system and method for indicating primary and secondary synchronization signals in a wireless communications system.

### BACKGROUND

In 3GPP Long Term Evolution (LTE) and Long Term Evolution-Advanced (LTE-A) systems, there are two downlink synchronization signals which are used by the UE to obtain the cell identity and frame timing: Primary synchronization signal and Secondary synchronization signal. The mapping of the sequence to resource elements depends on the frame structure. There are 504 unique physical-layer cell identities. The physical-layer cell identities are grouped into 168 unique physical-layer cell-identity groups, each group containing three unique identities. The grouping is such that each physical-layer cell identity is part of one and only one physical-layer cell-identity group. A physical-layer cell identity N_{ID}^{cell}=3N_{ID}⁽¹⁾+N_{ID}⁽²⁾ is thus uniquely defined by a number N_{ID}⁽¹⁾ in the range of 0 to 167, representing the physical-layer cell-identity group, and a number N_{ID}⁽²⁾ in the range of 0 to 2, representing the physical-layer identity within the physical-layer cell-identity group. The sequence d(n) used for the primary synchronization signal is generated from a frequency-domain Zadoff-Chu sequence. The sequence d(0) . . . , d(61) used for the second synchronization signal is an interleaved concatenation of two length-31 binary sequences. The concatenated sequence is scrambled with a scrambling sequence given by the primary synchronization signal.

### SUMMARY

A base station configured to communicate with a plurality of base stations via a backhaul link and configured to communicate with a plurality of subscriber stations is provided. The base station includes a transmit path configured to transmit data, reference signals, synchronization signals and control elements to at least one of the plurality of subscriber stations. The base station also includes processing circuitry configured to map primary synchronization signals (PSS) and secondary synchronization signals (SSS) onto each of a carrier of a first carrier type and a carrier of a second carrier type. The PSS and SSS (PSS/SSS) on the second carrier type are mapped onto different time locations than in the first carrier type. In addition, the PSS/SSS are mapped onto consecutive resource elements (REs) on each of the carrier of the first type and the carrier of the second type, wherein subcarrier indices k for the REs are represented by the following:

$$k = n - 31 + \frac{{N}_{RB}^{DL} {N}_{sc}^{RB}}{2} , n = 0 , … , 61$$

where N_{RB}^{DL} represents a total number of physical resource blocks (PRBs) in a respective carrier, and N_{sc}^{RB} is a number of subcarriers per PRB.

A method for mapping synchronization signals is provided. The method includes transmitting data, reference signals, synchronization signals and control elements to at least one of the plurality of subscriber stations. The method also includes mapping primary synchronization signals (PSS) and secondary synchronization signals (SSS) onto each of a carrier of a first carrier type and a carrier of a second carrier type. The PSS and SSS (PSS/SSS) on the second carrier type are mapped onto different time locations than in the first carrier type. In addition, the PSS/SSS are mapped onto consecutive resource elements (REs) on each of the carrier of the first type and the carrier of the second type, wherein subcarrier indices k for the REs are represented by the following:

$$k = n - 31 + \frac{{N}_{RB}^{DL} {N}_{sc}^{RB}}{2} , n = 0 , … , 61$$

where N_{RB}^{DL} represents a total number of physical resource blocks (PRBs) in a respective carrier, and N_{sc}^{RB} is a number of subcarriers per PRB.

A subscriber station configured to communicate with at least one base station, which is configured to communicate with a plurality of base stations via a backhaul link, is provided. The subscriber station includes receiver configured to receive data, reference signals, synchronization signals and control elements from the base station. The subscriber station also includes processing circuitry configured to read primary synchronization signals (PSS) and secondary synchronization signals (SSS) mapped onto each of a carrier of a first carrier type and a carrier of a second carrier type. The PSS and SSS (PSS/SSS) on the second carrier type are mapped onto different time locations than in the first carrier type. In addition, the PSS/SSS are mapped onto consecutive resource elements (REs) on each of the carrier of the first type and the carrier of the second type, wherein subcarrier indices k for the REs are represented by the following:

$$k = n - 31 + \frac{{N}_{RB}^{DL} {N}_{sc}^{RB}}{2} , n = 0 , … , 61$$

where N_{RB}^{DL} represents a total number of physical resource blocks (PRBs) in a respective carrier, and N_{sc}^{RB} is a number of subcarriers per PRB.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network according to an embodiment of the present disclosure;

FIG. 2A illustrates a high-level diagram of a wireless transmit path according to an embodiment of this disclosure;

FIG. 2B illustrates a high-level diagram of a wireless receive path according to an embodiment of this disclosure;

FIG. 3 illustrates a subscriber station according to an exemplary embodiment of the disclosure;

FIG. 4 illustrates a Cell Range Expansion (CRE) region according to embodiments of the present disclosure;

FIG. 5 illustrates a synchronization operation in carrier aggregation according to embodiments of the present disclosure;

FIG. 6 illustrates placement and configuration of new sync signals according to embodiments of the present disclosure;

FIG. 7 illustrates a process for radio resource control signalling according to embodiments of the present disclosure;

FIG. 8 illustrates RRC signaling of the new sync channel resources in measurement in measurement configuration message according to embodiments of the present disclosure;

FIGS. 9A through 9F illustrate synchronization signal mapping according to embodiments of the present disclosure;

FIGS. 10A and 10B illustrate synchronization signal mapping according to embodiments of the present disclosure;

FIGS. 11A through 11D illustrate synchronization signal mapping according to embodiments of the present disclosure;

FIG. 12 illustrates new PSS/SSS mapping alternatives according to embodiments of the present disclosure;

FIG. 13 illustrates placement of new sync signals according to embodiments of the present disclosure;

FIG. 14 illustrates a Coordinated Multipoint (CoMP) with Remote Radio Head having the same cell ID as the macro cell according to embodiments of the present disclosure; and

FIG. 15 illustrates a process for mapping synchronization according to embodiments of the present disclosure.

### DETAILED DESCRIPTION

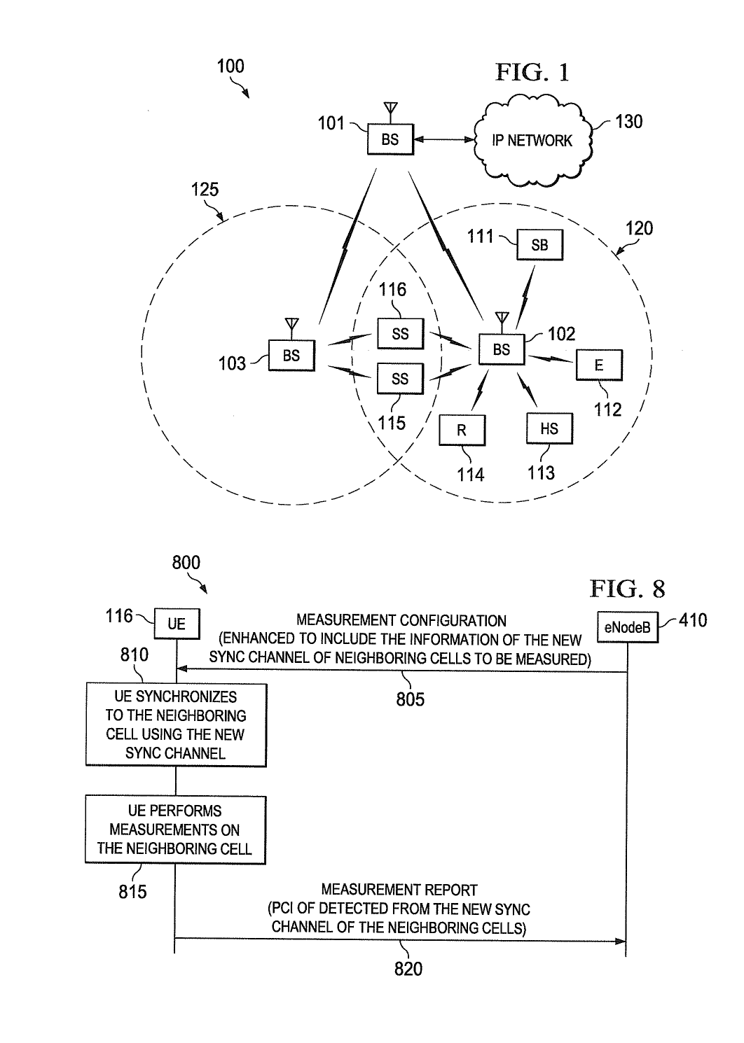

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein: (i) 3GPP Technical Specification No. 36.211, version 10.1.0, “E-UTRA, Physical Channels and Modulation” (hereinafter “REF1”); (ii) 3GPP Technical Specification No. 36.212, version 10.1.0, “E-UTRA, Multiplexing and Channel Coding” (hereinafter “REF2”); (iii) 3GPP Technical Specification No. 36.213, version 10.1.0, “E-UTRA, Physical Layer Procedures” (hereinafter “REF3”); and (iv) 3GPP Technical Specification No. 36.300, version 10.4.0 (hereinafter “REF4”).

FIG. 1 illustrates a wireless network 100 according to one embodiment of the present disclosure. The embodiment of wireless network 100 illustrated in FIG. 1 is for illustration only. Other embodiments of wireless network 100 could be used without departing from the scope of this disclosure.

The wireless network 100 includes eNodeB (eNB) 101, eNB 102, and eNB 103. The eNB 101 communicates with eNB 102 and eNB 103. The eNB 101 also communicates with Internet protocol (IP) network 130, such as the Internet, a proprietary IP network, or other data network.

Depending on the network type, other well-known terms may be used instead of “eNodeB,” such as “base station” or “access point”. For the sake of convenience, the term “eNodeB” shall be used herein to refer to the network infrastructure components that provide wireless access to remote terminals. In addition, the term user equipment (UE) is used herein to refer to remote terminals that can be used by a consumer to access services via the wireless communications network. Other well know terms for the remote terminals include “mobile stations” and “subscriber stations.”

The eNB 102 provides wireless broadband access to network 130 to a first plurality of user equipments (UEs) within coverage area 120 of eNB 102. The first plurality of UEs includes UE 111, which may be located in a small business; UE 112, which may be located in an enterprise; UE 113, which may be located in a WiFi hotspot; UE 114, which may be located in a first residence; UE 115, which may be located in a second residence; and UE 116, which may be a mobile device, such as a cell phone, a wireless laptop, a wireless PDA, or the like. UEs 111-116 may be any wireless communication device, such as, but not limited to, a mobile phone, mobile PDA and any mobile station (MS).

For the sake of convenience, the term “user equipment” or “UE” is used herein to designate any remote wireless equipment that wirelessly accesses an eNB, whether the UE is a mobile device (e.g., cell phone) or is normally considered a stationary device (e.g., desktop personal computer, vending machine, etc.). In other systems, other well-known terms may be used instead of “user equipment”, such as “mobile station” (MS), “subscriber station” (SS), “remote terminal” (RT), “wireless terminal” (WT), and the like.

The eNB 103 provides wireless broadband access to a second plurality of UEs within coverage area 125 of eNB 103. The second plurality of UEs includes UE 115 and UE 116. In some embodiment, eNBs 101-103 may communicate with each other and with UEs 111-116 using LTE or LTE-A techniques.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Although FIG. 1 depicts one example of a wireless network 100, various changes may be made to FIG. 1. For example, another type of data network, such as a wired network, may be substituted for wireless network 100. In a wired network, network terminals may replace eNBs 101-103 and UEs 111-116. Wired connections may replace the wireless connections depicted in FIG. 1.

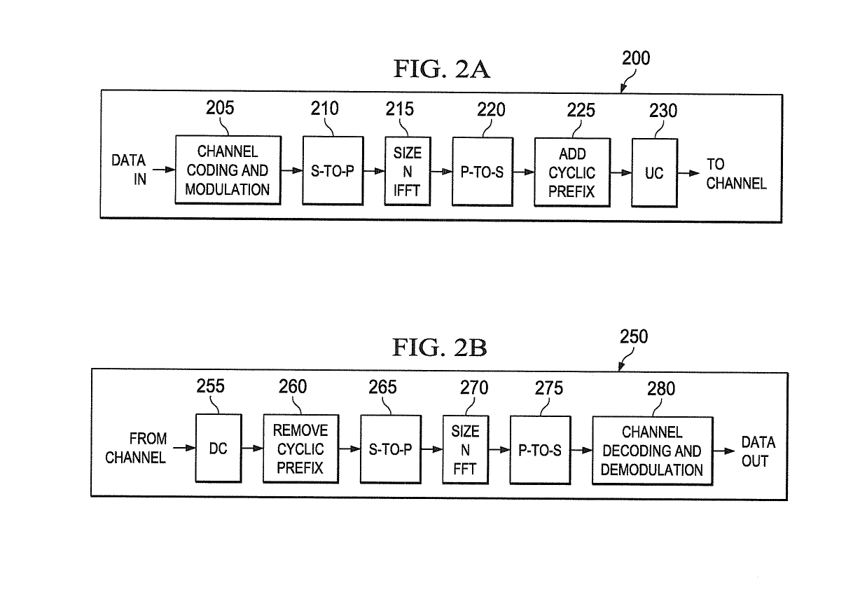

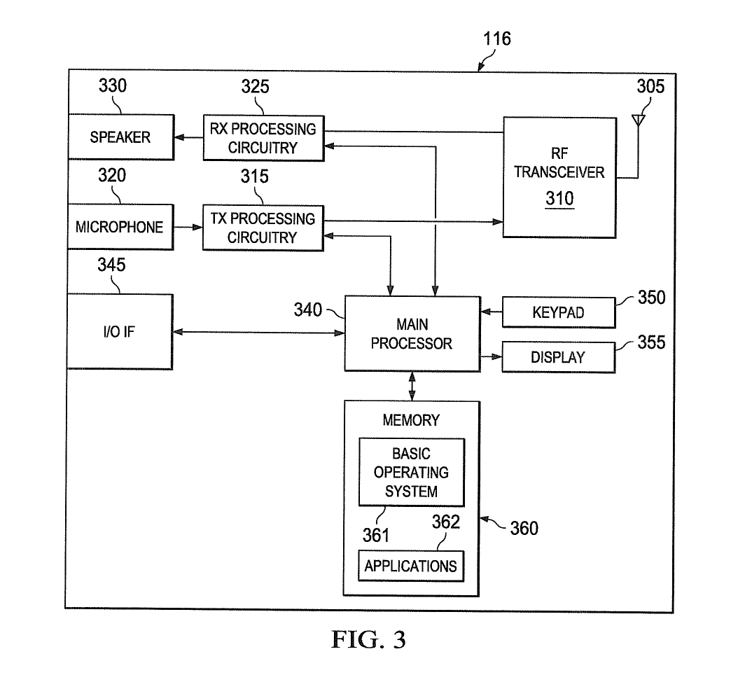

FIG. 2A is a high-level diagram of a wireless transmit path. FIG. 2B is a high-level diagram of a wireless receive path. In FIGS. 2A and 2B, the transmit path 200 may be implemented, e.g., in eNB 102 and the receive path 250 may be implemented, e.g., in a UE, such as UE 116 of FIG. 1. It will be understood, however, that the receive path 250 could be implemented in an eNB (e.g. eNB 102 of FIG. 1) and the transmit path 200 could be implemented in a UE.

Transmit path 200 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. Receive path 250 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware (e.g., a processor) or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In transmit path 200, channel coding and modulation block 205 receives a set of information bits, applies coding (e.g., LDPC coding) and modulates (e.g., Quadrature Phase Shift Keying (QPSK) or Quadrature Amplitude Modulation (QAM)) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in eNB 102 and UE 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at UE 116 after passing through the wireless channel and reverse operations to those at eNB 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of eNBs 101-103 may implement a transmit path that is analogous to transmitting in the downlink to UEs 111-116 and may implement a receive path that is analogous to receiving in the uplink from UEs 111-116. Similarly, each one of UEs 111-116 may implement a transmit path corresponding to the architecture for transmitting in the uplink to eNBs 101-103 and may implement a receive path corresponding to the architecture for receiving in the downlink from eNBs 101-103.

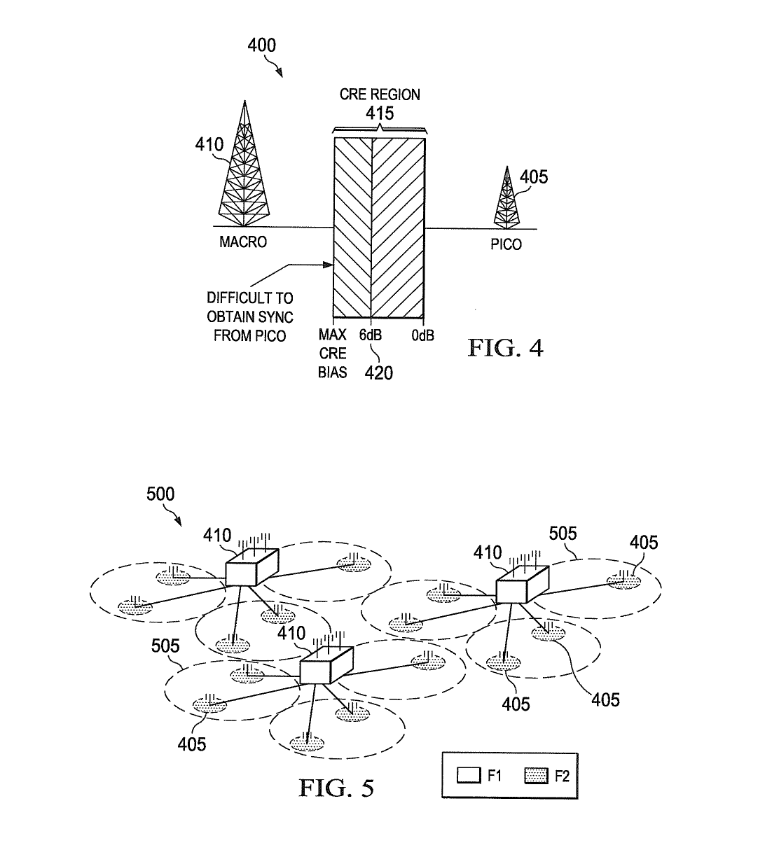

FIG. 3 illustrates a subscriber station according to embodiments of the present disclosure. The embodiment of subscriber station (UE 116) illustrated in FIG. 3 is for illustration only. Other embodiments of the wireless subscriber station could be used without departing from the scope of this disclosure.

UE 116 comprises antenna 305, radio frequency (RF) transceiver 310, transmit (TX) processing circuitry 315, microphone 320, and receive (RX) processing circuitry 325. SS 116 also comprises speaker 330, main processor 340, input/output (I/O) interface (IF) 345, keypad 350, display 355, and memory 360. Memory 360 further comprises basic operating system (OS) program 361 and a plurality of applications 362. The plurality of applications can include one or more of resource mapping tables (Tables 1-10 described in further detail herein below).

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In certain embodiments, main processor 340 is a microprocessor or microcontroller. Memory 360 is coupled to main processor 340. According to some embodiments of the present disclosure, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless subscriber station 116. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360, such as operations for CoMP communications and determining sync signals. Main processor 340 can move data into or out of memory 360, as required by an executing process. In some embodiments, the main processor 340 is configured to execute a plurality of applications 362, such as applications for CoMP communications and MU-MIMO communications. The main processor 340 can operate the plurality of applications 362 based on OS program 361 or in response to a signal received from BS 102. Main processor 340 is also coupled to I/O interface 345. I/O interface 345 provides subscriber station 116 with the ability to connect to other devices such as laptop computers and handheld computers. I/O interface 345 is the communication path between these accessories and main controller 340.

Main processor 340 is also coupled to keypad 350 and display unit 355. The operator of subscriber station 116 uses keypad 350 to enter data into subscriber station 116. Display 355 may be a liquid crystal display capable of rendering text and/or at least limited graphics from web sites. Alternate embodiments may use other types of displays.

In LTE and LTE-A systems, there are two downlink synchronization signals which are used by the UE to obtain the cell identity and frame timing: Primary synchronization signal (PSS) and Secondary synchronization signal (SSS). The sequence d(n) used for the primary synchronization signal is generated from a frequency-domain Zadoff-Chu sequence according to:

$${d}_{u} ( n ) = \{ \begin{matrix}{e}^{- j \frac{π un ( n + 1 )}{63}} & n = 0 , 1 , … , 30 \\ {e}^{- j \frac{π un ( n + 2 )}{63}} & n = 31 , 31 , … 61\end{matrix} \qquad [ Eqn . 1 ]$$

where the Zadoff-Chu root sequence index u is given by Table 1.

TABLE 6.11.1.1-1
Root indices for the primary synchronization signal.

| N_{ID}⁽²⁾ | Root index u |
|---|---|
| 0 | 25 |
| 1 | 29 |
| 2 | 34 |

The mapping of the sequence to resource elements depends on the frame structure. The UE shall not assume that the primary synchronization signal is transmitted on the same antenna port as any of the downlink reference signals. The UE shall not assume that any transmission instance of the primary synchronization signal is transmitted on the same antenna port, or ports, used for any other transmission instance of the primary synchronization signal.

The sequence d(n) shall be mapped to the resource elements according to:

$${a}_{k , j} = d ( n ) , n = 0 , … , 61 \\ k = n - 31 + \frac{{N}_{RB}^{DL} {N}_{sc}^{RB}}{2} \qquad [ Eqn . 2 ]$$

For frame structure type 1, the primary synchronization signal is mapped to the last OFDM symbol in slots 0 and 10.

For frame structure type 2, the primary synchronization signal is mapped to the third OFDM symbol in subframes 1 and 6. Resource elements (k,l) in the OFDM symbols used for transmission of the primary synchronization signal where

$$k = n - 31 + \frac{{N}_{RB}^{DL} {N}_{sc}^{RB}}{2}$$

$$n = - 5 , - 5 , … - 1 , 62 , 63 , … 66$$

are reserved and not used for transmission of the primary synchronization signal.

The sequence d(0) . . . , d(61) used for the second synchronization signal is an interleaved concatenation of two length-31 binary sequences. The concatenated sequence is scrambled with a scrambling sequence given by the primary synchronization signal.

The combination of two length-31 sequences defining the secondary synchronization signal differs between subframe 0 and subframe 5 according to:

$$d ( 2 n ) = \{ \begin{matrix}{s}_{0}^{{m}_{0}} ( n ) {c}_{0} ( n ) & in subframe 0 \\ {s}_{1}^{{m}_{1}} ( n ) {c}_{0} ( n ) & in subframe 5\end{matrix} \\ {d}_{u} ( n ) = \{ \begin{matrix}{s}_{1}^{{m}_{1}} ( n ) {c}_{1} ( n ) {z}_{1}^{( {m}_{0} )} ( n ) & in subframe 0 \\ {s}_{0}^{{m}_{0}} ( n ) {c}_{1} ( n ) {z}_{1}^{( {m}_{1} )} ( n ) & in subframe 5\end{matrix} \qquad [ Eqn . 3 ]$$

where 0≦n≦30. The indices m₀ and m₁ are derived from the physical-layer cell-identity group N_{ID}⁽¹⁾ according to:

$${m}_{0} = {m}^{′} mod 31 \\ {m}_{1} = ( {m}_{0} + ⌊ {m}^{′} / 31 ⌋ + 1 ) mod 31 \\ {m}^{′} = {N}_{ID}^{( 1 )} + q ( q + 1 ) / 2 , \\ q = ⌊ \frac{{N}_{ID}^{( 1 )} + {q}^{′} ( {q}^{′} + 1 ) / 2}{30} ⌋ , {q}^{′} = ⌊ {N}_{ID}^{( 1 )} / 30 ⌋ \qquad [ Eqn . 4 ]$$

where the output of the above expression is listed in Table 2.

The two sequences s₀^{(m}^{₀}⁾(n) and s₁^{(m}^{₁}⁾(n) are defined as two different cyclic shifts of the m-sequence \tilde{s}(n) according to:

s₀^{(m}^{₀}⁾(n)=\tilde{s}((n+m₀)mod 31)

s₁^{(m}^{₁}⁾(n)=\tilde{s}((n+m₁)mod 31)[Eqn. 5]

where \tilde{s}(i)=1−2x(i), 0≦i≦30, is defined by:

x( i̅+5)=(x( i̅+2)+x( i̅))mod 2, 0≦ i̅≦25 [Eqn. 6]

with initial conditions x(0)=0, x(1)=0, x(2)=0, x(3)=0, x(4)=1.

The two scrambling sequences c₀(n) and c₁(n) depend on the primary synchronization signal and are defined by two different cyclic shifts of the m-sequence \tilde{c}(n) according to:

c₀(n)=\tilde{c}((n+N_{ID}⁽²⁾)mod 31)

c₁(n)=\tilde{c}((n+N_{ID}⁽²⁾+3)mod 31) [Eqn. 7]

where N_{ID}⁽²⁾ε{0,1,2} is the physical-layer identity within the physical-layer cell identity group N_{ID}⁽¹⁾ and \tilde{c}(1)=1−2x(i), 0≦i≦30, is defined by:

x(ī+5)=(x(ī+3)+x(ī))mod 2, 0≦ī≦25 [Eqn. 8]

with initial conditions x(0)=0, x(1)=0, x(2)=0, x(3)=0, x(4)=1.

The scrambling sequences z₁^{(m}^{₀}⁾(n) and z₁^{(m}^{₁}⁾(n) are defined by a cyclic shift of the m-sequence \tilde{z}(n) according to:

z₁^{(m}^{₀}⁾(n)=\tilde{z}((n+(m₀ mod 8))mod 31) [Eqn. 9]

z₁^{(m}^{₁}⁾(n)=\tilde{z}((n+(m₁ mod 8))mod 31) [Eqn. 10]

where m₀ and m₁ are obtained from Table 2 and \tilde{z}(i)=1−2x(i), 0≦i≦30, is defined by:

x(ī+5)=(x(ī+4)+x(ī+2)+x(ī+1)+x(ī))mod 2, 0≦ī≦25 [Eqn. 11]

with initial conditions x(0)=0, x(1)=0, x(2)=0, x(3)=0, x(4)=1.

TABLE 2
Mapping between physical-layer cell-identity
group N_{ID}⁽¹⁾ and the indices m₀ and m₁.

| N_{ID}⁽¹⁾ | m₀ | m₁ | N_{ID}⁽¹⁾ | m₀ | m₁ | N_{ID}⁽¹⁾ | m₀ | m₁ | N_{ID}⁽¹⁾ | m₀ | m₁ | N_{ID}⁽¹⁾ | m₀ | m₁ |
|---|---|---|---|---|---|---|---|---|---|---|---|---|---|---|
| 0 | 0 | 1 | 34 | 4 | 6 | 68 | 9 | 12 | 102 | 15 | 19 | 136 | 22 | 27 |
| 1 | 1 | 2 | 35 | 5 | 7 | 69 | 10 | 13 | 103 | 16 | 20 | 137 | 23 | 28 |
| 2 | 2 | 3 | 36 | 6 | 8 | 70 | 11 | 14 | 104 | 17 | 21 | 138 | 24 | 29 |
| 3 | 3 | 4 | 37 | 7 | 9 | 71 | 12 | 15 | 105 | 18 | 22 | 139 | 25 | 30 |
| 4 | 4 | 5 | 38 | 8 | 10 | 72 | 13 | 16 | 106 | 19 | 23 | 140 | 0 | 6 |
| 5 | 5 | 6 | 39 | 9 | 11 | 73 | 14 | 17 | 107 | 20 | 24 | 141 | 1 | 7 |
| 6 | 6 | 7 | 40 | 10 | 12 | 74 | 15 | 18 | 108 | 21 | 25 | 142 | 2 | 8 |
| 7 | 7 | 8 | 41 | 11 | 13 | 75 | 16 | 19 | 109 | 22 | 26 | 143 | 3 | 9 |
| 8 | 8 | 9 | 42 | 12 | 14 | 76 | 17 | 20 | 110 | 23 | 27 | 144 | 4 | 10 |
| 9 | 9 | 10 | 43 | 13 | 15 | 77 | 18 | 21 | 111 | 24 | 28 | 145 | 5 | 11 |
| 10 | 10 | 11 | 44 | 14 | 16 | 78 | 19 | 22 | 112 | 25 | 29 | 146 | 6 | 12 |
| 11 | 11 | 12 | 45 | 15 | 17 | 79 | 20 | 23 | 113 | 26 | 30 | 147 | 7 | 13 |
| 12 | 12 | 13 | 46 | 16 | 18 | 80 | 21 | 24 | 114 | 0 | 5 | 148 | 8 | 14 |
| 13 | 13 | 14 | 47 | 17 | 19 | 81 | 22 | 25 | 115 | 1 | 6 | 149 | 9 | 15 |
| 14 | 14 | 15 | 48 | 18 | 20 | 82 | 23 | 26 | 116 | 2 | 7 | 150 | 10 | 16 |
| 15 | 15 | 16 | 49 | 19 | 21 | 83 | 24 | 27 | 117 | 3 | 8 | 151 | 11 | 17 |
| 16 | 16 | 17 | 50 | 20 | 22 | 84 | 25 | 28 | 118 | 4 | 9 | 152 | 12 | 18 |
| 17 | 17 | 18 | 51 | 21 | 23 | 85 | 26 | 29 | 119 | 5 | 10 | 153 | 13 | 19 |
| 18 | 18 | 19 | 52 | 22 | 24 | 86 | 27 | 30 | 120 | 6 | 11 | 154 | 14 | 20 |
| 19 | 19 | 20 | 53 | 23 | 25 | 87 | 0 | 4 | 121 | 7 | 12 | 155 | 15 | 21 |
| 20 | 20 | 21 | 54 | 24 | 26 | 88 | 1 | 5 | 122 | 8 | 13 | 156 | 16 | 22 |
| 21 | 21 | 22 | 55 | 25 | 27 | 89 | 2 | 6 | 123 | 9 | 14 | 157 | 17 | 23 |
| 22 | 22 | 23 | 56 | 26 | 28 | 90 | 3 | 7 | 124 | 10 | 15 | 158 | 18 | 24 |
| 23 | 23 | 24 | 57 | 27 | 29 | 91 | 4 | 8 | 125 | 11 | 16 | 159 | 19 | 25 |
| 24 | 24 | 25 | 58 | 28 | 30 | 92 | 5 | 9 | 126 | 12 | 17 | 160 | 20 | 26 |
| 25 | 25 | 26 | 59 | 0 | 3 | 93 | 6 | 10 | 127 | 13 | 18 | 161 | 21 | 27 |
| 26 | 26 | 27 | 60 | 1 | 4 | 94 | 7 | 11 | 128 | 14 | 19 | 162 | 22 | 28 |
| 27 | 27 | 28 | 61 | 2 | 5 | 95 | 8 | 12 | 129 | 15 | 20 | 163 | 23 | 29 |
| 28 | 28 | 29 | 62 | 3 | 6 | 96 | 9 | 13 | 130 | 16 | 21 | 164 | 24 | 30 |
| 29 | 29 | 30 | 63 | 4 | 7 | 97 | 10 | 14 | 131 | 17 | 22 | 165 | 0 | 7 |
| 30 | 0 | 2 | 64 | 5 | 8 | 98 | 11 | 15 | 132 | 18 | 23 | 166 | 1 | 8 |
| 31 | 1 | 3 | 65 | 6 | 9 | 99 | 12 | 16 | 133 | 19 | 24 | 167 | 2 | 9 |
| 32 | 2 | 4 | 66 | 7 | 10 | 100 | 13 | 17 | 134 | 20 | 25 | — | — | — |
| 33 | 3 | 5 | 67 | 8 | 11 | 101 | 14 | 18 | 135 | 21 | 26 | — | — | — |

The mapping of the sequence to resource elements depends on the frame structure. In a sub-frame for frame structure type 1 and in a half-frame for frame structure type 2, the same antenna port as for the primary synchronization signal shall be used for the secondary synchronization signal.

The sequence d(n) shall be mapped to resource elements according to:

$${a}_{k , 1} = d ( n ) , n = 0 , … , 61 \\ k = n - 31 + \frac{{N}_{RB}^{DL} {N}_{sc}^{RB}}{2} \\ l = \{ \begin{matrix}{N}_{symb}^{DL} - 2 & in slots 0 and 10 & for frame structure type 1 \\ {N}_{symb}^{DL} - 1 & in slots 1 and 11 & for frame structure type 2\end{matrix} \qquad [ Eqn . 12 ]$$

Resource elements (k,l) where:

are reserved and not used for transmission of the secondary synchronization signal.

The extension carrier is characterized by the following:

### a) No PBCH/SIB/Paging;

### b) No PSS/SSS;

### c) No Rel.10 DL CCHs;

### d) No CRS;

e) Associated with a Rel.10 carrier;
f) Measurements are performed on Rel.10 carriers;
g) Benefits including:
a. The inefficiencies (large overhead and challenging performance) associated with transmissions of CCHs in small BWs can be avoided (by cross-scheduling an extension carrier with small BW);
   i. With Rel.10 cross-scheduling, 1 OFDM symbol still needs to be reserved for DL CCHs (7.1% unnecessary overhead when nothing is transmitted);
   ii. For CA-based ICIC, CRS existence and/or interference can also be avoided for additional savings;
b. Desensitization issues when a DL frequency is close to an UL frequency can be avoided (reduced power, proper MCS selection, and Hybrid Automatic Repeat Request (HARQ) can be utilized for PDSCH near the band edge; this is inefficient or not possible to do for transmissions of DL CCHs which, due to interleaving, occupy substantially the entire BW);
c. Simple Coordinated Multipoint (CoMP) operation as PDCCH discrepancy among cells and CRS interference (if CRS does not exist) can be avoided;
d. Some small overhead reductions can be achieved due to the absence of transmissions for synchronization channels and broadcast control channels; and
   h) Only possible for CA-capable UEs.

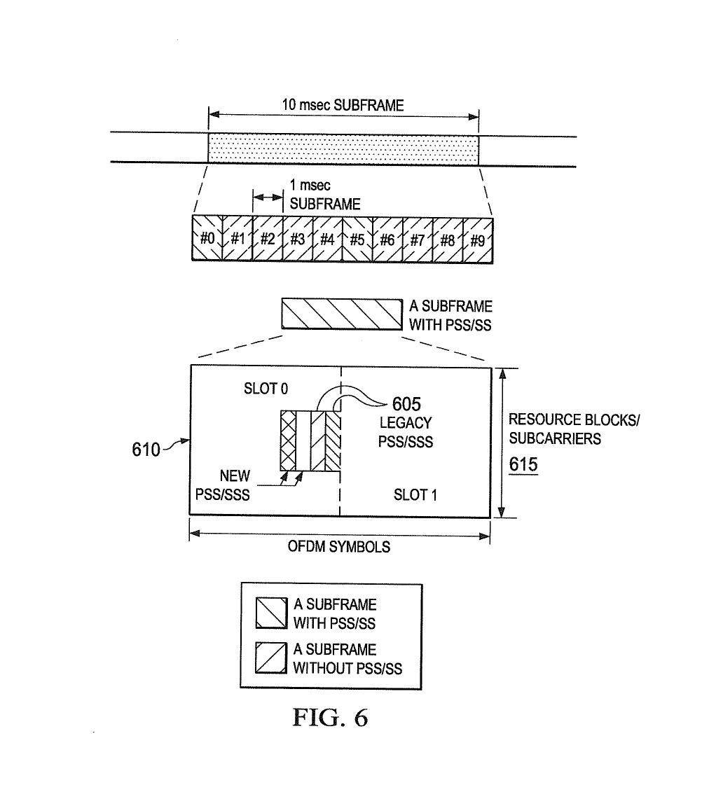

FIG. 4 illustrates a Cell Range Expansion (CRE) region according to embodiments of the present disclosure. The CRE region 500 shown in FIG. 4 is for illustration only. Other embodiments could be used without departing from the scope of this disclosure.

In one heterogeneous network deployment scenario, a number of pico base stations (“picos”, also referenced as remote radio heads (RRH)) 405 are deployed within the coverage of a macro base station (“macro”) 410. Cell-range expansion (CRE) is a well-known technique that lets the network offload some traffic from the macro 410 to one or more of the picos 405, especially when the macro 410 is overloaded. When CRE 400 is implemented, one or more UEs receiving the strongest DL signal from the macro 410 are instructed to connect to a pico 405 and receive DL control/data signals from (and transmit UL signals to) the pico 405. CRE is implemented for those UEs receiving the strongest signal from the macro 410, while at the same time the difference of the received signal powers from the macro 410 and a pico 405 is within a max CRE bias. In certain embodiments, UEs falling in the CRE region 415 can be instructed to receive from the pico 405, even though UE receives the strongest DL signals from the macro 410. One well-known problem of CRE is that when the max CRE bias is too large, the UE instructed to receive DL signals from pico 405 cannot acquire a sync from pico 405. This issue occurs as a result of the sync signals from the macro 410 and the pico 405 being transmitted in the same time-frequency resources. Therefore, the UE cannot obtain sync from pico 405 when the signal strength difference is too high, such as more than 6 dB 420.

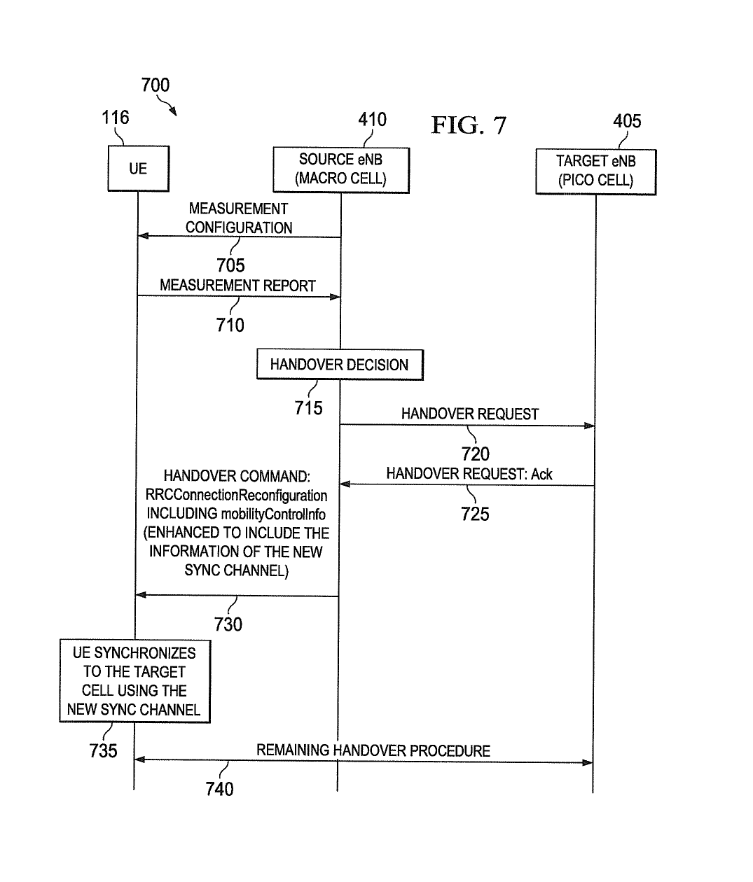

FIG. 5 illustrates a synchronization operation in carrier aggregation according to embodiments of the present disclosure. The embodiment of the synchronization operation shown in FIG. 5 is for illustration only. Other embodiments could be used without departing from the scope of this disclosure.

In one carrier aggregation (CA) scenario (denoted by CA scenario 4 in REF4), a number of picos 405 are deployed within the coverage 505 of a macro 410, in which the macro 410 transmits (and receives) signals from a carrier F1 (or CC1) and a pico 405 transmits (and receives) signals from F2 (or CC2). When CC1 and CC2 are backward compatible carriers, the UE is able to sync to respective carriers according to the legacy sync mechanism. Alternatively, when CC1 is a backward compatible carrier but CC2 is non-backward compatible carrier (e.g., extension carrier which does not transmit sync signals), the UE may not be able to obtain sync to CC2.

Embodiments of the present disclosure provide new designs of sync signals in order to resolve these example issues arising in the advanced wireless telecommunication systems.

In certain embodiments, new sync signals, as well as Rel-sync signals (Rel-8 PSS/SSS), are transmitted in a backward compatible component carrier (CC), i.e., a 3GPP E-UTRA (LTE) Rel-8 or Rel-9 or Rel-10 compatible carrier. The new sync signal helps CRE UEs to obtain sync to a pico 405 in the heterogeneous network illustrated in FIG. 4, for example.

In certain embodiments, new sync signals are transmitted in a non-backward compatible component carrier (CC), e.g., in an extension carrier or in a new carrier type (NCT). The new sync signal helps UEs to obtain sync to a pico 405 operating in CC2 in carrier aggregation scenario 4 illustrated in FIG. 5, for example.

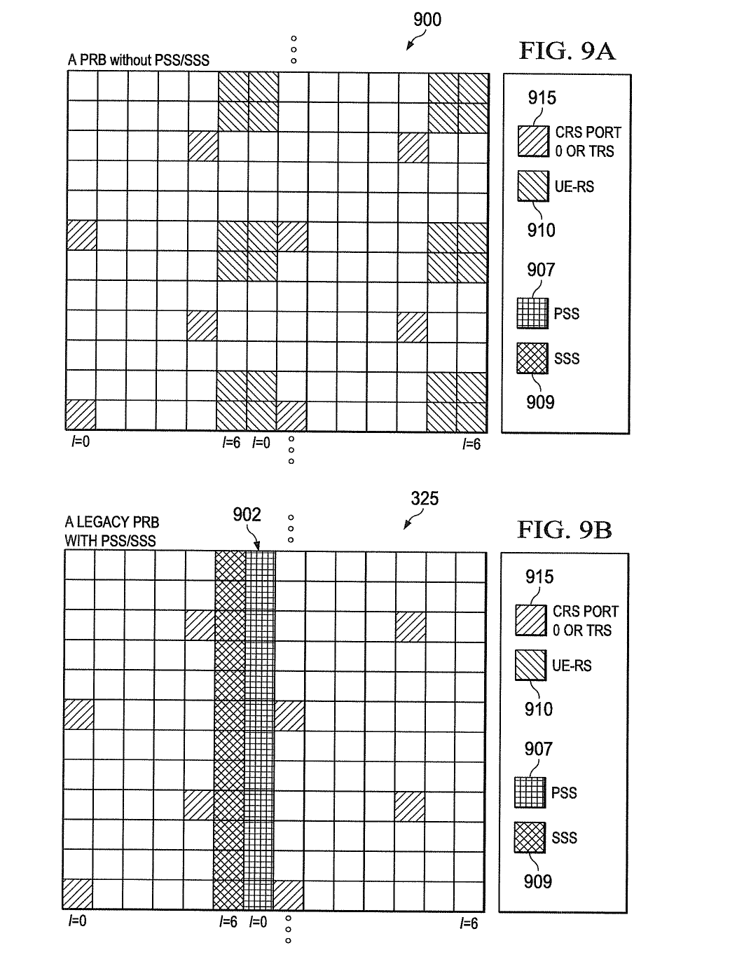

FIG. 6 illustrates placement and configuration of new sync signals according to embodiments of the present disclosure. The embodiment of the sync signals 600 shown in FIG. 6 is for illustration only. Other embodiments could be used without departing from the scope of this disclosure.

In legacy wireless systems, such as LTE Rel-8, 9, 10, sync signals 605 are periodically transmitted in pre-assigned sub-frames 610 and frequency 615 resources. No configuration signals are conveyed to UEs for indicating the time-frequency resources assigned for the sync signals 605. UEs purely rely on blind detection to detect a sync signal 605. Although the periodic (and continuous) transmission of sync signal could be essential for supporting UEs' initial access, because the UEs cannot obtain any configuration from the network 500 (or eNodeB 410) before the initial access, the periodic transmission may not be essential for UEs' handover and sync acquisition of an extension carrier, in which case the UE is able to obtain configurations from the network 500. Furthermore, the periodic sync transmission prevents the network 500 from flexibly consuming energy and utilizing time-frequency resources. Owing to these drawbacks of the periodic transmission, aperiodic transmission of sync signals configured by the network 500 (transmission of sync signals on demand basis) seem to be useful for better energy efficiency and flexible resource utilization. Furthermore, the aperiodic sync signal transmission is suitable even when the network 500 has only occasional access of a bandwidth (BW), of which scenario arises in cognitive access scenarios. With aperiodic sync signal transmission, the network 500 does not need to always transmit sync signals, and hence the network 500 can make sure that the network's sync signals do not interfere to another network.

In certain embodiments, the network 500 supports two component carriers (or two cells), a primary component carrier (PCC, or PCell) and a secondary component carrier (SCC, or SCell), of which the PCC is E-UTRA Rel-8 compatible, while the SCC is non-backward compatible, i.e., E-UTRA Rel-10 or below UEs cannot access the SCC. An example network is illustrated in FIG. 5. An advanced UE, such as UE 116, performs initial access and connects to the PCC first. In certain embodiments, when connected to the PCC, the network 500 decides to configure the SCC to the advanced UE 116, and configures to receive sync signals from the SCC in a designated time-frequency sync resources in the SCC by a Radio Resource Control (RRC) signaling. The RRC configuration may include at least one of the following information for the sync signal resources:

Slot numbers (ε{0, 1, . . . , 19} in a radio frame) and OFDM symbol numbers;

Bandwidth (e.g., in terms of PRBs);

Periodicity of sync signals (e.g., in terms of sub-frames or slots); and

Physical cell ID (PCI) of the SCC. In some cases, at least one of the following can be configured instead of PCI.

(a) PSS sequence number;

(b) SSS sequence number

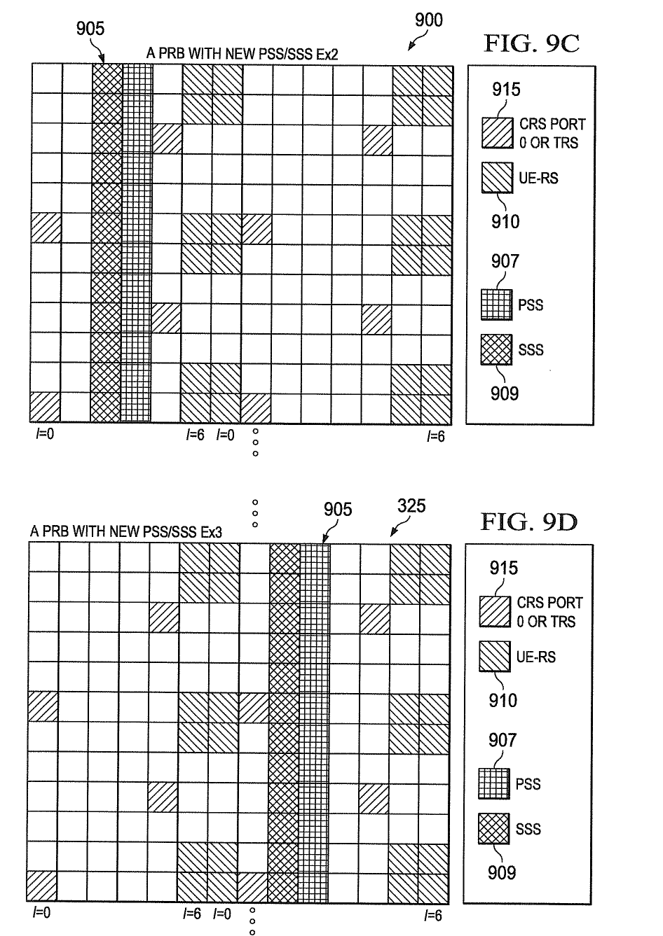

FIG. 7 illustrates a process for radio resource control signalling according to embodiments of the present disclosure. The embodiment of the RRC signalling 700 shown in FIG. 7 is for illustration only. Other embodiments could be used without departing from the scope of this disclosure.

In certain embodiments, a heterogeneous network is composed of a macro 410 and at least one pico 410, such as illustrated in FIG. 4. UE 116 performs initial access and is initially connected to the macro 410, according to E-UTRA Rel-8/9/10 initial access mechanism. That is, the macro 410 transmits a measurement configuration message 705. UE 116 responds with a measurement report 710. When the network (or eNodeB 410) desires to do CRE for UE 116 (in block 715), the network configures UE 116 to hand over from the macro 410 to a pico 405. The macro 410 communicates the hand over request with the pico 405 in steps 720 and 725. During the handover process, the macro 410 transmits an RRC signaling 730 to UE 116 informing the new sync signal resources of the pico 405. For example, the RRC message about the new sync signal resources can be included in the RRC connection reconfiguration message including the mobility control information. Thereafter, UE 116 and the pico 405 complete the hand over procedure 740.

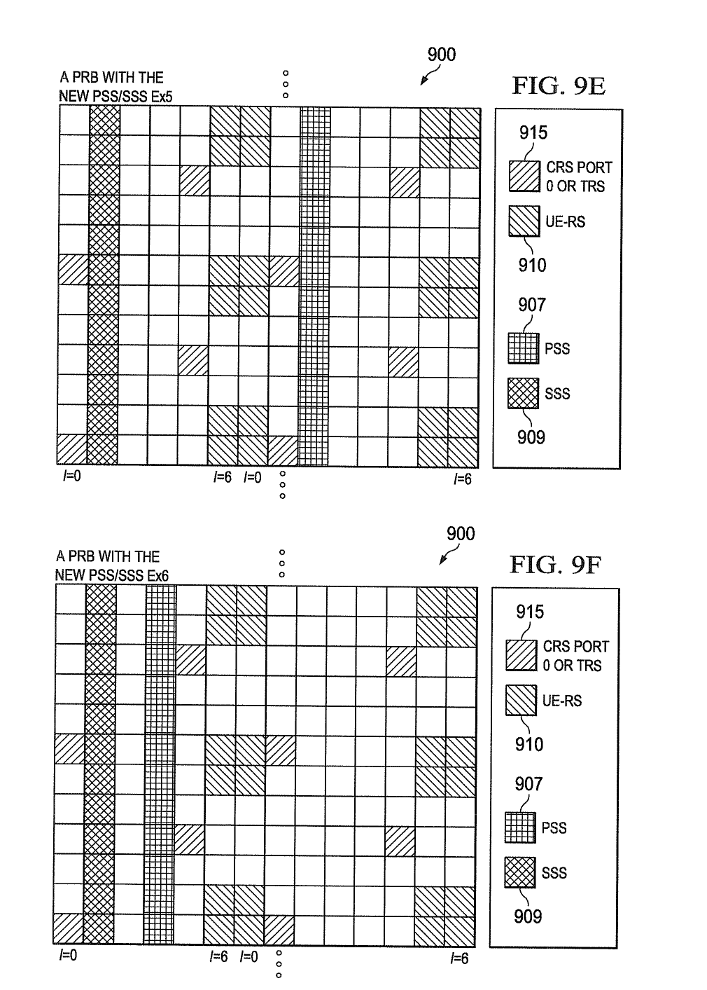

FIG. 8 illustrates RRC signaling of the new sync channel resources in measurement in measurement configuration message according to embodiments of the present disclosure. The embodiment of the RRC signaling shown in FIG. 8 is for illustrations only. Other embodiments could be used without departing from the scope of this disclosure.

In certain embodiments, the information about the designated time-frequency sync resources for the non-backward compatible carrier (can correspond to an SCell for carrier aggregation or a pico cell with CRE in a heterogeneous network) is signaled in measurement configuration message 805 (e.g., in broadcast message such as in SIB or in unicast message; e.g., in measObjectEUTRA REF4). That is, the new sync information is included in the measurement configuration for RRC connected mode. UE 116 synchronizes to the neighboring cell (e.g., pico 405 or another macro 410) using the new sync channel in block 810. In block 815, UE 116 performs measurements on the neighboring cell. Therefore, UE 116 responds with the measurement report 820, which contains PCI detected from the new sync channel of the neighboring cells.

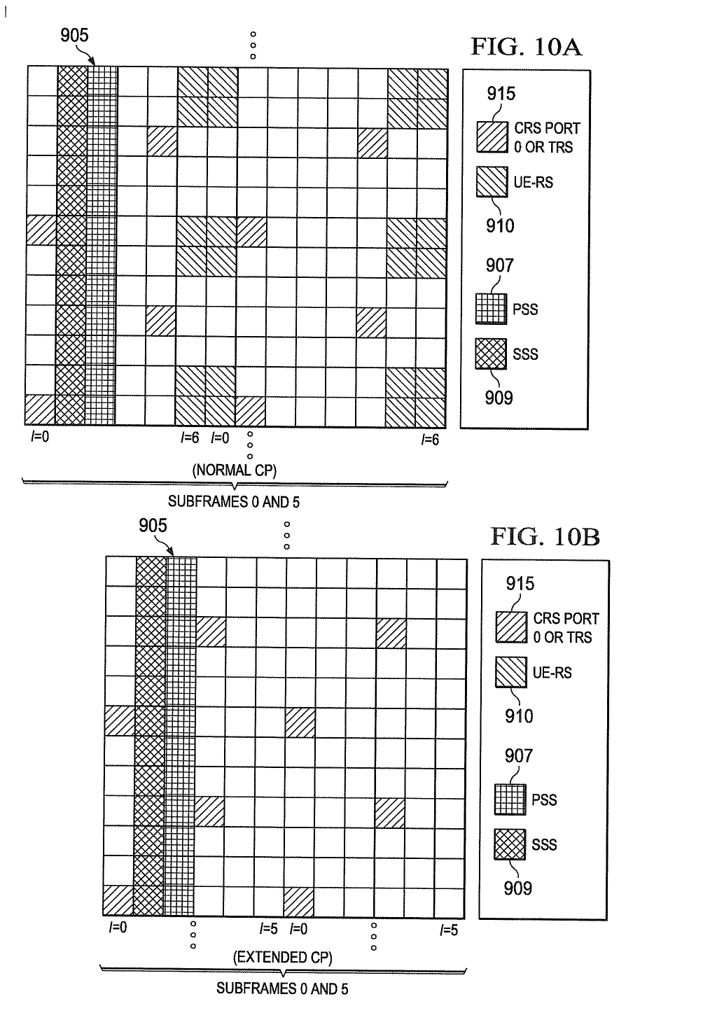

FIGS. 9A through 9F illustrate synchronization signal mapping according to embodiments of the present disclosure. The embodiments of the synchronization mapping shown in FIGS. 9A through 9F are for illustration only. Other embodiments could be used without departing from the scope of the present disclosure.

In certain embodiments, the PSS and SSS (PSS/SSS) are mapped onto each of a carrier of a first type and a carrier of a second type, on different time locations. For example, the new synchronization signals (e.g., on carrier of a new carrier type) are transmitted in the same sub-frames as those for Rel-8 PSS/SSS, and are mapped to the same subcarriers as those of the Rel-8 PSS/SSS, but in different OFDM symbols from those of Rel-8 PSS/SSS, as illustrated in FIG. 6. In one example, the new sync signals include PSS and SSS, and a UE configured to read the new PSS/SSS obtains physical cell ID (PCID) from the new PSS/SSS.

FIGS. 9A through 9F illustrate a few examples to map PSS/SSS 905 according to the method presented in the current embodiment. The PSS/SSS 905 includes a PSS 907 and a SSS 909. FIG. 9A shows a PRB pair 900 without PSS/SSS 905, where UE-specific RS (UE-RS) 910 RE locations and CRS port 0 (or timing RS (TRS)) 915 RE locations are also indicated. FIG. 9B shows a PRB pair 900 that contains legacy PSS/SSS 902 according to the 3GPP LTE Rel-8/9/10 specifications. That is, the legacy PSS/SSS 902 are located in the fifth and sixth symbols.

In one method, the OFDM symbol numbers to map the new PSS/SSS 905 are adjacent, and some examples are:

Ex1) As in FIG. 6, the new PSS 907 and SSS 909 are located in the OFDM symbols l=N_{symb}^{DL}−3 and l=N_{symb}^{DL}−4 in the first slot, respectively;

Ex2) The new PSS 907 and SSS 909 are located in the OFDM symbols l=N_{symb}^{DL}−4 and l=N_{symb}^{DL}−5 in the first slot, respectively as shown in FIG. 9C;

Ex3) The new PSS 907 and SSS 909 are located in the OFDM symbols l=2 and l=1 in second slot, respectively (FIG. 9D);

Ex4) The new PSS 907 and SSS 909 are located in the OFDM symbols l=3 and l=2 in second slot, respectively.

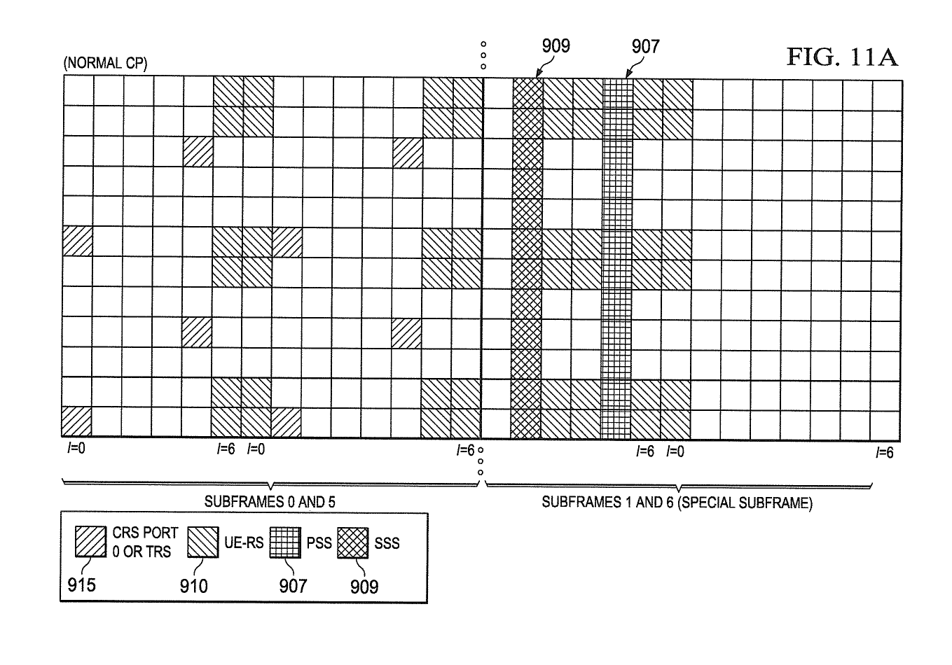

FIGS. 10A and 10B illustrate synchronization signal mapping according to embodiments of the present disclosure. The embodiments of the synchronization mapping shown in FIGS. 10A and 10B are for illustration only. Other embodiments could be used without departing from the scope of the present disclosure.

Ex5) FIGS. 10A and 10B show another example PSS/SSS mapping according to the present disclosure. It has additional benefit of having the same location for both normal and extended CPs. In this case, the new PSS 907 and SSS 909 are located in the OFDM symbols l=2 and l=1 in the first slot of sub-frame numbers 0 and 5, respectively, regardless of whether sub-frame type is normal-CP or extended-CP. This PSS/SSS mapping can be applied to both Frequency Division Duplex (FDD) and Time Division Duplex (TDD) systems, in case a common mapping is desired for FDD and TDD system in the extension carrier.

When the new PSS/SSS 905 are mapped according to the any of the examples above, the benefits are:

No collision occurs between the legacy PSS/SSS 902 and the new PSS/SSS 905;

The new PSS/SSS 905 do not collide with UE-RS ports 7-14, and hence the PRBs with the new PSS/SSS 905 can be used for PDSCH transmissions with UE-RS 910, which has not been possible in Rel-10 LTE.

When the new PSS/SSS 905 are mapped according to Ex2, Ex3, Ex4 and Ex7, there is an additional benefit, i.e.,: the new PSS/SSS 905 do not collide with CRS ports 0 910, regardless of extended CP or normal CP. Note that CRS port 0 910 can be used for timing synchronization in extension carriers, and hence no collision between CRS and PSS/SSS is desired.

In another method, the two OFDM symbols carrying the new PSS 907 and the new SSS 909 are not adjacent, which is different from the legacy mapping where two OFDM symbols carrying the legacy PSS and the legacy SSS are adjacent. Furthermore, the number of OFDM symbols between the new PSS 907 and the new SSS 909 is different from the number of OFDM symbols between the legacy TDD PSS and the legacy FDD SSS which is 3. This way, the new PSS/SSS 905 is not confused with neither TDD PSS/SSS nor FDD PSS/SSS. Some examples for the OFDM symbol numbers to map the new PSS/SSS according to this method are:

Ex5) The new PSS and SSS are located in the OFDM symbols l=1 in the second slot and l=1 in the first slot, respectively, as shown in FIG. 9E wherein a PRB 900 in which the new PSS 907 and SSS 909 are distributed;

Ex6) The new PSS and SSS are located in the OFDM symbols l=3 and l=1 in the first slot, respectively as shown in FIG. 9F wherein a PRB 900 in which the new PSS 907 and SSS 909 are distributed.

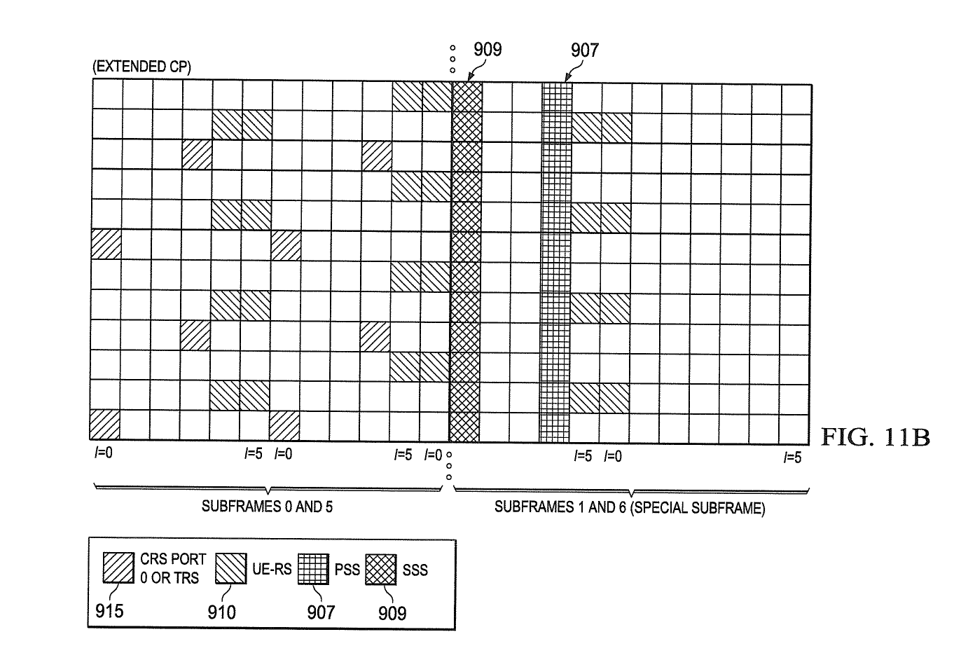

FIGS. 11A through 11D illustrate synchronization signal mapping according to embodiments of the present disclosure. The embodiments of the synchronization mapping shown in FIGS. 11A through 11D are for illustration only. Other embodiments could be used without departing from the scope of the present disclosure.

In another method, the two OFDM symbols carrying the new PSS 907 and the new SSS 909 are spaced apart with the same number of OFDM symbols as the PSS and the SSS in the legacy (Rel-8) TDD system are spaced apart, while still ensuring that the new PSS/SSS 905 locations do not collide with the locations for Rel-10 UE-RS and Rel-8 CRS port 0 910.

Ex8) FIGS. 11A through 11D show one example PSS/SSS mapping according to the current method. It has a benefit of having the same PSS-SSS OFDM symbol spacing for Rel-8 legacy TDD and the NCT, and the implementation of PSS/SSS 905 reception at UE 116 may be reused for the legacy carrier and the NCT. In this case, the new PSS 907 is located in the OFDM symbol l=N_{symb}^{DL}−3 in the first slot of sub-frames 1 and 6; whereas the new SSS 909 is located in the OFDM symbol l=N_{symb}^{DL}−6 in the first slot of sub-frames 1 and 6. The same mapping rule is applied regardless of whether sub-frame type is normal-CP or extended-CP. This PSS/SSS 905 mapping can be applied to TDD system in the extension carrier. Note that the DM RS mapping for the special sub-frame shown in FIGS. 11A-11D is for certain TDD UL-DL configurations; the PSS/SSS mapping disclosed here applies to the other TDD UL-DL configurations as well.

In certain embodiments, Ex 7 and Ex 8 are used for FDD and TDD PSS/SSS mapping for the NCT. The mapping of the PSS/SSS sequence to resource elements depends on the frame structure and the carrier type.

In the case of Primary Synchronization Signals:

For frame structure type 1 (FDD) configured for the legacy carrier type (implying Rel-8/9/10 compatible carrier), the primary synchronization signal shall be mapped to the last OFDM symbol in slots 0 and 10.

For frame structure type 1 (FDD) configured for the new carrier type, the primary synchronization signal shall be mapped to OFDM symbol number l=2 in slots 0 and 10.

For frame structure type 2 (TDD) configured for the legacy carrier type (implying Rel-8/9/10 compatible carrier), the primary synchronization signal shall be mapped to the third OFDM symbol in sub-frames 1 and 6. That is, for time division duplex (TDD), and for frame structure type 2, the PSS is mapped to a third OFDM symbol in sub-frames 1 and 6.

For frame structure type 2 (TDD) configured for the new carrier type, the primary synchronization signal shall be mapped to OFDM symbol number l=N_{symb}^{DL}−3 in slots 2 and 12.

In the case of Secondary Synchronization Signals:

In a sub-frame for frame structure type 1 and in a half-frame for frame structure type 2, the same antenna port as for the primary synchronization signal shall be used for the secondary synchronization signal.

For the legacy carrier type, the sequence d(n) shall be mapped to resource elements according to:

$${a}_{k , 1} = d ( n ) , n = 0 , … , 61 \\ k = n - 31 + \frac{{N}_{RB}^{DL} {N}_{sc}^{RB}}{2} \\ l = \{ \begin{matrix}{N}_{symb}^{DL} - 2 & in slots 0 and 10 & for frame structure type 1 \\ {N}_{symb}^{DL} - 1 & in slots 1 and 11 & for frame structure type 2\end{matrix} \qquad [ Eqn . 13 ]$$

Resource elements (k,l) where:

$$k = n - 31 + \frac{{N}_{RB}^{DL} {N}_{sc}^{RB}}{2} \\ l = \{ \begin{matrix}{N}_{symb}^{DL} - 2 & in slots 0 and 10 & for frame structure type 1 \\ {N}_{symb}^{DL} - 1 & in slots 1 and 11 & for frame structure type 2\end{matrix} \\ n = - 5 , - 4 , … , - 1 , 62 , 63 , … 66 \qquad [ Eqn . 14 ]$$

are reserved and not used for transmission of the secondary synchronization signal.

For the new carrier type, the sequence d(n) shall be mapped to resource elements according to:

$${a}_{k , 1} = d ( n ) , n = 0 , … , 61 \\ k = n - 31 + \frac{{N}_{RB}^{DL} {N}_{sc}^{RB}}{2} \\ l = \{ \begin{matrix}1 & in slots 0 and 10 & for frame structure type 1 \\ {N}_{symb}^{DL} - 6 & in slots 2 and 12 & for frame structure type 2\end{matrix} \qquad [ Eqn . 15 ]$$

Resource elements (k,l) where:

$$k = n - 31 + \frac{{N}_{RB}^{DL} {N}_{sc}^{RB}}{2} \\ l = \{ \begin{matrix}1 & in slots 0 and 10 & for frame structure type 1 \\ {N}_{symb}^{DL} - 6 & in slots 2 and 12 & for frame structure type 2\end{matrix} \\ n = - 5 , - 4 , … , - 1 , 62 , 63 , … 66 \qquad [ Eqn . 16 ]$$

are reserved and not used for transmission of the secondary synchronization signal.

In certain embodiments, the new sync signals are placed in the same sub-frames and in the same frequency (or subcarrier or PRB) resources as the legacy sync signals to accommodate legacy UEs. Placing the new sync signals in the same sub-frames and in the same frequency (or subcarrier or PRB) resources as the legacy sync signals for the legacy UEs can be a better choice than placing them in any other places. If the new sync signals were placed in other places than those proposed in this embodiment, more scheduling restriction is imposed on the legacy UEs. This is because the legacy UEs do not know the existence of the new sync signals, and legacy UEs are not likely scheduled in those resources with new sync signals for fear of reliability (or throughput) impacts. Furthermore, in certain embodiments, placing the new sync signals in the same BW as the legacy sync signals is beneficial since the advanced UE 116 is allowed to rely on the legacy mechanism to determine the center of the bandwidth.

Alternatively, when the new PSS 907 and/or SSS 909 are transmitted according to this embodiment, the new PSS/SSS 905 is distinguishable from the legacy PSS/SSS. Otherwise, a legacy UE may be able to read the new PSS/SSS 905 as well, and the legacy UE may get confused not knowing which sync signals to obtain sync.

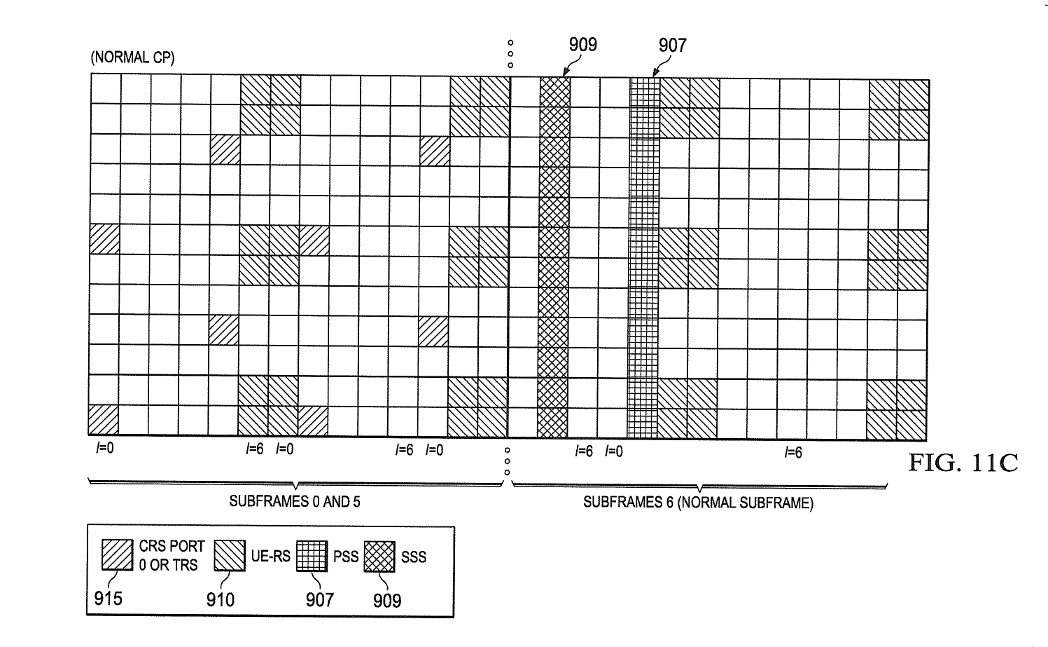

To resolve this issue, we consider the following alternatives illustrated in FIG. 12. FIG. 12 illustrates new PSS/SSS mapping alternatives according to embodiments of the present disclosure. The embodiment of the PSS/SSS mapping alternatives shown in FIG. 12 is for illustration only. Other embodiments could be used without departing from the scope of this disclosure.

In certain embodiments, the sequences for new PSS 907 and new SSS 909 are generated as a function of the sequences used for the legacy PSS and the legacy SSS.

The function should make sure that the legacy sync signals and the new sync signals are sufficiently distinguishable so that legacy UEs are not confused with the newly defined sync signals. At the same time, by reusing the legacy sequences, the new UEs will not have much burden to implement new sequences for the new PSS/SSS 905.

Some alternative methods for the generation and mapping of the new PSS 907 and the SSS 909 according to this embodiment are listed below and illustrated in FIG. 12. Note that the below alternatives are described according to the new PSS/SSS 905 mapping option of the OFDM symbols l=N_{symb}^{DL}−3 and l=N_{symb}^{DL}−4 in the first slot for ease of description. The description of the below alternatives can be easily modified by replacing the OFDM symbols numbers of the new PSS/SSS 905 when the new PSS/SSS mapping option is any two OFDM symbol numbers, some of which is illustrated in FIGS. 9A-9F and the associated embodiment.

Alt 1 (Ex1 1205): Each of the new PSS and the new SSS is mapped to the subcarriers in the reverse direction of the legacy PSS and the legacy SSS.

In one example, the new PSS is mapped onto the subcarriers on OFDM symbol l=N_{symb}^{DL}−3, while the new SSS is mapped onto the subcarriers on OFDM symbol N_{symb}^{DL}−4 in slots 0 and 10 or frame structure type 1 (i.e., FDD).

In one example, the new PSS is identical to the legacy PSS defined in Section 6.11.1 in REF1 and the new PSS mapping is done as in the following. That is, the PSS/SSS are mapped onto consecutive resource elements (REs) on each of the carrier of the first type and the carrier of the second type. The sequence d(n) shall be mapped to the resource elements according to:

$${a}_{k , 1} = d ( n ) , n = 0 , … , 61 \\ k = 31 - n + \frac{{N}_{RB}^{DL} {N}_{sc}^{RB}}{2} \qquad [ Eqn . 17 ]$$

The new SSS is identical to the legacy SSS defined in Section 6.11.2 in REF1 and the new SSS mapping is done as the following:

The sequence d(n) shall be mapped to resource elements according to:

$${a}_{k , 1} = d ( n ) , n = 0 , … , 61 \\ k = 31 - n + \frac{{N}_{RB}^{DL} {N}_{sc}^{RB}}{2} \qquad [ Eqn . 18 ]$$

Alt 2 (Ex2 1210): A cyclic shift is applied to each of the new PSS and the new SSS, and the cyclically shifted sync signal is mapped to the subcarriers for the PSS and the SSS. In the below examples, shift is the shift used for the cyclic shifting operation. δ_{shift} can be a constant, e.g., δ_{shift}=31, which is the half of the sequence length.

In one example, the new PSS is mapped onto the subcarriers on OFDM symbol l=N_{symb}^{DL}−3, while the new SSS is mapped onto the subcarriers on OFDM symbol N_{symb}^{DL}−4 in slots 0 and 10 or frame structure type 1 (i.e., FDD).

In one example, the new PSS is generated by cyclically shifting the legacy PSS defined in Section 6.11.1 in REF1 and mapped to the resource elements as in the following:

The sequence d(n) shall be mapped to the resource elements according to:

$${a}_{k , 1} = d ( ( n - {δ}_{shift} ) mod 62 ) , n = 0 , … , 61 \\ k = n - 31 + \frac{{N}_{RB}^{DL} {N}_{sc}^{RB}}{2} \qquad [ Eqn . 19 ]$$

The new SSS is generated by cyclically shifting the legacy SSS defined in Section 6.11.2 in REF1 and mapped to the resource elements as the following:

The sequence d(n) shall be mapped to resource elements according to:

$${a}_{k , 1} = d ( ( n - {δ}_{shift} ) mod 62 ) , n = 0 , … , 61 \\ k = n - 31 + \frac{{N}_{RB}^{DL} {N}_{sc}^{RB}}{2} \qquad [ Eqn . 20 ]$$

In another example, the new PSS is generated by cyclically shifting the legacy PSS defined in Section 6.11.1 in REF1 and reversely mapped to the resource elements as in the following:

The sequence d(n) shall be mapped to the resource elements according to:

$${a}_{k , 1} = d ( ( n - {δ}_{shift} ) mod 62 ) , \\ n = 0 , … , 61 \\ k = 31 - n + \frac{{N}_{RB}^{DL} {N}_{sc}^{RB}}{2} \qquad [ Eqn . 21 ]$$

The new SSS is generated by cyclically shifting the legacy SSS defined in Section 6.11.2 in REF1 and reversely mapped to the resource elements as the following:

The sequence d(n) shall be mapped to resource elements according to:

$${a}_{k , 1} = d ( ( n - {δ}_{shift} ) mod 62 ) , \\ n = 0 , … , 61 \\ k = 31 - n + \frac{{N}_{RB}^{DL} {N}_{sc}^{RB}}{2} \qquad [ Eqn . 22 ]$$

Alt 3(Ex3 1215): Each of the new PSS and the new SSS is sequentially mapped to the subcarriers, but is interleaved in multiple OFDM symbols. In the below examples, n_{offset} is the offset used for the interleaving operation. The n_{offset} can be a constant, e.g., n_{offset}=31, which is the half of the sequence length.

In one example, the new PSS is identical to the legacy PSS defined in Section 6.11.1 in REF1 and the new PSS mapping is done as in the following:

The sequence d(n) shall be mapped to the resource elements according to:

$${a}_{k , 1} = d ( n ) , \\ n = 0 , … , 61 \\ k = n - 31 + \frac{{N}_{RB}^{DL} {N}_{sc}^{RB}}{2} , \\ 1 = \{ \begin{matrix}{N}_{symb}^{DL} - 3 & n = 0 , … , {n}_{offset} \\ {N}_{symb}^{DL} - 4 & n = {n}_{offset} + 1 , … , 61\end{matrix} \qquad [ Eqn . 23 ]$$

in slots 0 and 10 or frame structure type 1 (i.e., FDD). That is, for frequency division duplex (FDD), and for frame structure type 1, the PSS is mapped to a last OFDM symbol in slots 0 and 10.

The new SSS is generated by cyclically shifting the legacy SSS defined in Section 6.11.2 in REF1 and mapped to the resource elements as the following:

The sequence d(n) shall be mapped to resource elements according to:

$${a}_{k , 1} = d ( n ) , \\ n = 0 , … , 61 \\ k = n - 31 + \frac{{N}_{RB}^{DL} {N}_{sc}^{RB}}{2} , \\ 1 = \{ \begin{matrix}{N}_{symb}^{DL} - 4 & n = 0 , … , {n}_{offset} \\ {N}_{symb}^{DL} - 3 & n = {n}_{offset} + 1 , … , 61\end{matrix} \qquad [ Eqn . 24 ]$$

in slots 0 and 10 or frame structure type 1 (i.e. FDD).

In another example, the new PSS is identical to the legacy PSS defined in Section 6.11.1 in REF1 and the new PSS mapping is done as in the following (reverse mapping):

The sequence d(n) shall be mapped to the resource elements according to:

$${a}_{k , 1} = d ( n ) , \\ n = 0 , … , 61 \\ k = 31 - n + \frac{{N}_{RB}^{DL} {N}_{sc}^{RB}}{2} , \\ 1 = \{ \begin{matrix}{N}_{symb}^{DL} - 3 & n = 0 , … , {n}_{offset} \\ {N}_{symb}^{DL} - 4 & n = {n}_{offset} + 1 , … , 61\end{matrix} \qquad [ Eqn . 25 ]$$

in slots 0 and 10 or frame structure type 1 (i.e. FDD).

The new SSS is generated by cyclically shifting the legacy SSS defined in Section 6.11.2 in REF1 and mapped to the resource elements as the following (reverse mapping):

The sequence d(n) shall be mapped to resource elements according to:

$${a}_{k , 1} = d ( n ) , \\ n = 0 , … , 61 \\ k = 31 - n + \frac{{N}_{RB}^{DL} {N}_{sc}^{RB}}{2} , \\ 1 = \{ \begin{matrix}{N}_{symb}^{DL} - 4 & n = 0 , … , {n}_{offset} \\ {N}_{symb}^{DL} - 3 & n = {n}_{offset} + 1 , … , 61\end{matrix} \qquad [ Eqn . 26 ]$$

in slots 0 and 10 or frame structure type 1 (i.e. FDD).

Alt 4 (Ex4 in 1220): Each of the new PSS 907 and the new 909 SSS is sequentially mapped to the subcarriers just like the legacy PSS/SSS. However, the new PSS comes earlier in time than the new SSS, which is different from the mapping where the legacy PSS comes later in time than the legacy SSS. This way, legacy UEs are not confused by the new sync signals. In one example, the new PSS is mapped onto the subcarriers on OFDM symbol l=N_{symb}^{DL}−4 while the new SSS is mapped onto the subcarriers on OFDM symbol N_{symb}^{DL}−3, in slots 0 and 10 or frame structure type 1 (i.e., FDD).

In certain embodiments, only the SSS 909 without PSS 907 can be configured to be transmitted on an extension carrier. This method can prevent legacy UEs from camping on the extension carrier, because in the legacy UEs' implementation PSS are detected first before the SSS. Note that in this case SSS can be used for UEs' time and frequency synchronization.

For the time-frequency location of the SSS, we consider the following:

In one example, time-frequency location of the SSS can be configured by RRC, where the RRC configuration may include at least one of the following:

Periodicity P in terms of sub-frame, SSS are transmitted in every P sub-frames;

Sub-frame offset P₀. SSS are transmitted in sub-frames P₀, P₀+P, and so on in each (radio) frame;

OFDM symbol number, which contains SSS in the SSS sub-frame; and

PRB numbers (or subcarrier numbers), which contains SSS in the SSS sub-frame.

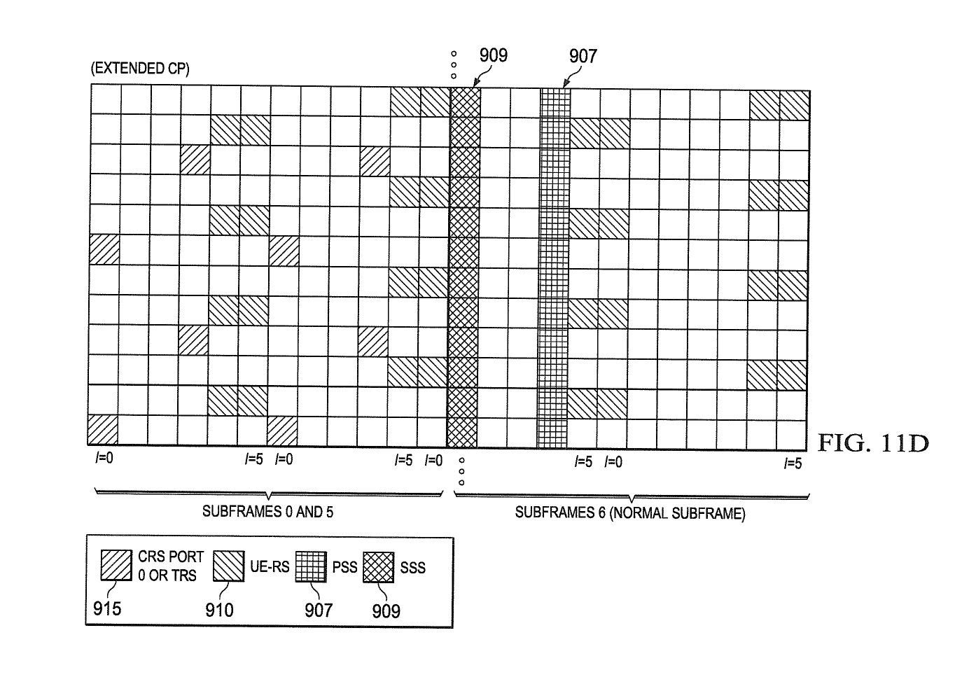

FIG. 13 illustrates placement of new sync signals according to embodiments of the present disclosure. The embodiment of the new signals shown in FIG. 13 is for illustration only. Other embodiments could be used without departing from the scope of the disclosure.

In another example, time-frequency location of the SSS is fixed in the standard and not signaled to UEs: (See FIG. 13).

The sub-frames 1305 that contain SSS are identical to those in the backward compatible carriers, i.e., sub-frames #0 and #5 in case of FDD;

Frequency location of the SSS is also identical to that of the backward compatible carriers, i.e., the SSS are transmitted in the center 6 PRBs; and

An OFDM symbol in the first slot (or slot 0) is selected for the transmission of SSS in the SSS sub-frames:

Alt 1: The OFDM symbol to transmit the SSS is identical to the one in the backward compatible carriers, i.e., the second to the last OFDM symbol 1310 in the first slot (or slot 0); and

Alt 2: The OFDM symbol to transmit the SSS is the same as the one for the PSS in the backward compatible carriers, i.e., the last OFDM symbol 1315 in the first slot (or slot 0).

In certain embodiments, whether UE 116 can use PSS or not in an extension carrier is configured by an RRC signaling transmitted in the primary component carrier. In other words, UE 116 is informed by an RRC signaling transmitted in the primary component carrier of whether PSS is configured in the extension carrier or not. In still other words, UE 116 is informed by an RRC signaling transmitted in the primary component carrier of whether the PSS power is non-zero or zero.

When UE 116 is configured to access PSS, or when UE 116 is informed that (non-zero power) PSS is configured in the extension carrier, UE 116 can use both PSS and SSS to get synchronization to the extension carrier.

When UE 116 is not configured to access PSS, or when the UE is informed that PSS is not configured in the extension carrier, the UE uses SSS to get synchronization to the extension carrier.

When the PSS is not configured, or when zero-power PSS is configured, two options can be considered for UEs' 116 assumption on the PSS REs.

In a first option, when UE 116 is scheduled in the DL PRBs containing the PSS REs, UE 116 rate matches around the PSS REs. This provides UE implementation simplicity in that UE 116 does not need to implement two different types of rate matching blocks depending on whether the PSS is configured or not.

In a second option, when UE 116 is scheduled in the DL PRBs containing the PSS REs, UE 116 expects valid data symbols are transmitted in the PSS REs. This provides increased DL throughput as compared to the first option, as the PSS REs are not wasted.

Here, the underlying assumption is that UE 116 knows the time frequency location of PSS REs, e.g., as specified in the standard specification, or by an RRC signaling.

Soft-cell partitioning

In 36.331 v10.1.0, the following configuration is defined for CSI-RS:

CSI-RS-Config

The IE CSI-RS-Config is used to specify the CSI (Channel-State Information) reference signal configuration.

CSI-RS-Config information elements

-- ASN1 START

| | |
|---|---|
| CSI-RS-Config-r10 ::= | SEQUENCE { |

| | |
|---|---|
| csi-RS-r10 | CHOICE { |

| | |
|---|---|
| release | NULL, |
| setup | SEQUENCE { |

| | |
|---|---|
| antennaPortsCount-r10 | ENUMERATED {an1, an2, an4, an8}, |
| resourceConfig-r10 | INTEGER (0..31), |

| | |
|---|---|
| subframeConfig-r10 | INTEGER (0..154), |

| | |
|---|---|
| p-C-r10 | INTEGER (−8..15) |

}

| | | |
|---|---|---|
| } | OPTIONAL, | -- Need ON |

| | |
|---|---|
| zeroTxPowerCSI-RS-r10 | CHOICE { |
| release | NULL, |
| setup | SEQUENCE { |

| | |
|---|---|
| zeroTxPowerResourceConfigList-r10 | BIT STRING (SIZE (16)), |
| zeroTxPowerSubframeConfig-r10 | INTEGER (0..154) |

}

| | |
|---|---|
| } | OPTIONAL -- |

Need ON
}
-- ASN1STOP

CSI-RS-Config field descriptions

antennaPortsCount
Parameter represents the number of antenna ports used for transmission of
CSI reference signals where an1 corresponds to 1, an2 to 2 antenna ports
etc. see TS 36.211 [21, 6.10.5].
p-C
Parameter: P_{c}, see TS 36.213 [23, 7.2.5].
resourceConfig
Parameter: CSI reference signal configuration, see TS 36.211 [21, table
6.10.5.2-1 and 6.10.5.2-2].
subframeConfig
Parameter: I_{CSI-RS}, see TS 36.211 [21, table 6.10.5.3-1].
zeroTxPowerResourceConfigList
Parameter: ZeroPowerCSI-RS, see TS 36.211 [21, 6.10.5.2].
zeroTxPowerSubframeConfig
Parameter: I_{CSI-RS}, see TS 36.211 [21, table 6.10.5.3-1].

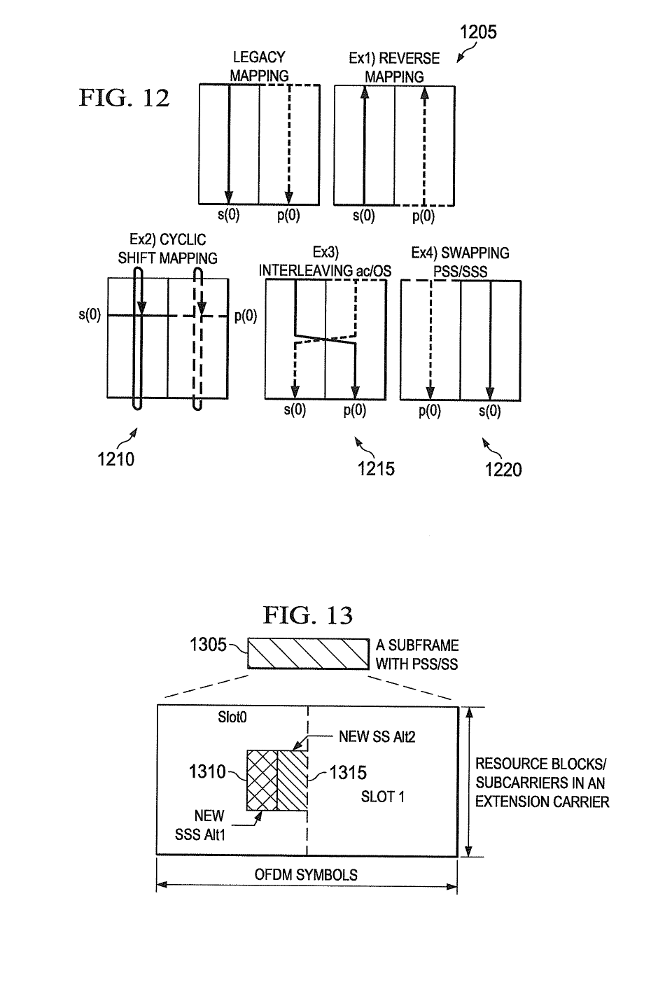

FIG. 14 illustrates a Coordinated Multipoint (CoMP) with Remote Radio Head having the same cell ID as the macro cell according to embodiments of the present disclosure. The embodiment of the CoMP 1400 shown in FIG. 14 is for illustration only. Other embodiments could be used without departing from the scope of the disclosure.

In the example shown in FIG. 14, where macro 0 transmits CSI-RS according to CSI-RS configuration 1, RRH1 1405 transmits CSI-RS according to CSI-RS configuration 2, and RRH2 1410 transmits CSI-RS according to CSI-RS configuration 3, where the three CSI-RS configurations are defined below.

CSI-RS configuration 1 comprises at least the following fields:

resourceConfig=RC1

subframeConfig=SC1

antennaPortCount=APC1

CSI-RS configuration 2 comprises at least the following fields:

resourceConfig=RC2

subframeConfig=SC2

antennaPortCount=APC2

CSI-RS configuration 3 comprises at least the following fields:

resourceConfig=RC3

subframeConfig=SC3

antennaPortCount=APC3.

UE 116, UE 115 and UE 113 are advanced UEs, implementing not only Rel-10 features but also new features introduced in Rel-11.

In certain embodiments, for CoMP operation, UE 115 configured to do soft-cell partitioning and is configured with two CSI-RS configurations, i.e., CSI-RS configuration 1 and CSI-RS configuration 2. In this case, UE 115 needs to identify one CSI-RS configuration out of the two configurations to determine n_{SCID2}. Once the one CSI-RS configuration is determined, UE 115 calculates n_{SCID2} based on the field values of the one CSI-RS configuration, and receives UE-RS scrambled with an initialization cᵢₙᵢₜ=(└nₛ/2┘+1)·(2N_{ID}^{cell}+1)·2¹⁶+n_{SCID2}·2+n_{SCID}. Example methods for a UE to determine the one CSI-RS configuration (i.e., resourceConfig, subframeConfig, antennaPortCount) to be used for determining n_{SCID2} out of the two configurations are listed below:

The one CSI-RS configuration to determine n_{SCID2} is explicitly identified by a PHY signaling. In one example, one bit information field is introduced in UL DCI format(s), e.g., DCI format 0/0A and DCI format-4 to indicate one of the two CSI-RS configurations.

TABLE 3
Explicit PHY signaling example

| The one bit information field in the UL | |
|---|---|
| DCI format(s) | Meaning |
| 0 | A first CSI-RS configuration |
| 1 | A second CSI-RS configuration |

Some examples of determining n_{SCID2} are listed below, where X is a parameter providing means to TPs to control the UE-RS scrambling behavior. For example, Xε{0, 1, . . . , 2^{N}^{ₓ}−1} is an Nₓ bit parameter. For singaling of X, two alternatives are listed below.

Alt 0: The parameter X is fixed to be 0, and not signaled;

Alt 1: The parameter X is semi-statically signaled in the RRC layer;

Alt 2: The parameter X is dynamically signaled in a DCI format;

Some examples of determining n_{SCID2} are listed below, where ñ_{SCID2} is a function of RC=RC1, SC=SC1, APC=APC1:

n_{SCID2}=ñ_{SCID2}·(1+X) [Eqn. 27]

Here, the multiplication of (1+X) expands the possible values for the UE-RS scrambling initialization cᵢₙᵢₜ.

n_{SCID2}=ñ_{SCID2}·X [Eqn. 28]

Here, the multiplication of X expands the possible values for the UE-RS scrambling initialization cᵢₙᵢₜ, and at the same time gives flexibility of turning off the soft-cell partitioning.

n_{SCID2}=ñ_{SCID2}+X [Eqn. 29]

Here, the addition of X lets eNodeB have flexibility to choose the UE-RS scrambling initialization cᵢₙᵢₜ, e.g., to intentionally configure a different UE-RS scrambling to a UE than the one configured by the CSI-RS configuration.

Some examples of determining ñ_{SCID2} include:

ñ_{SCID2}=g(RC). In this case, n_{SCID2} only depends on the CSI-RS pattern;

ñ_{SCID2}=g(RC)·(I_{CSI-RS} mod 5). Here, (I_{CSI-RS} mod 5) is applied to ensure that at most 5 different scrambling initializations are generated with possible values of I_{CSI-RS}, where 5 corresponds to the minimum configurable period for CSI-RS sub-frames. In this case, n_{SCID2} is an 8-bit quantity;

ñ_{SCID2}=g(RC)·(I_{CSI-RS} mod 80). Here, (I_{CSI-RS} mod 80) is applied to ensure that at most 80 different scrambling initializations are generated with possible values of I_{CSI-RS}, where 80 corresponds to the maximum configurable period for CSI-RS sub-frames. In this case, n_{SCID2} is a 12-bit quantity;

ñ_{SCID2}=g(RC)·Δ_{CSI-RS}. Here, A CSI-RS is applied to ensure that at most T_{CSI-RS} different scrambling initializations are generated with possible values of I_{CRI-RS}.

In these examples, Δ_{CSI-RS} is CSI-RS subframe offset derived from I_{CSI-RS}=SC1 using Table 4.

Furthermore, some alternatives of determining the function g(RC) are:

g(RC)=RC; and

g(RC)=RC mod 10.

TABLE 4
CSI reference signal sub-frame configuration

| | CSI-RS periodicity | CSI-RS subframe offset |
|---|---|---|
| CSI-RS-SubframeConfig | T_{CSI-RS} | Δ_{CSI-RS} |
| I_{CSI-RS} | (subframes) | (subframes) |
| 0-4 | 5 | I_{CSI-RS} |
| 5-14 | 10 | I_{CSI-RS}-5 |
| 15-34 | 20 | I_{CSI-RS}-15 |
| 35-74 | 40 | I_{CSI-RS}-35 |
| 75-154 | 80 | I_{CSI-RS}-75 |

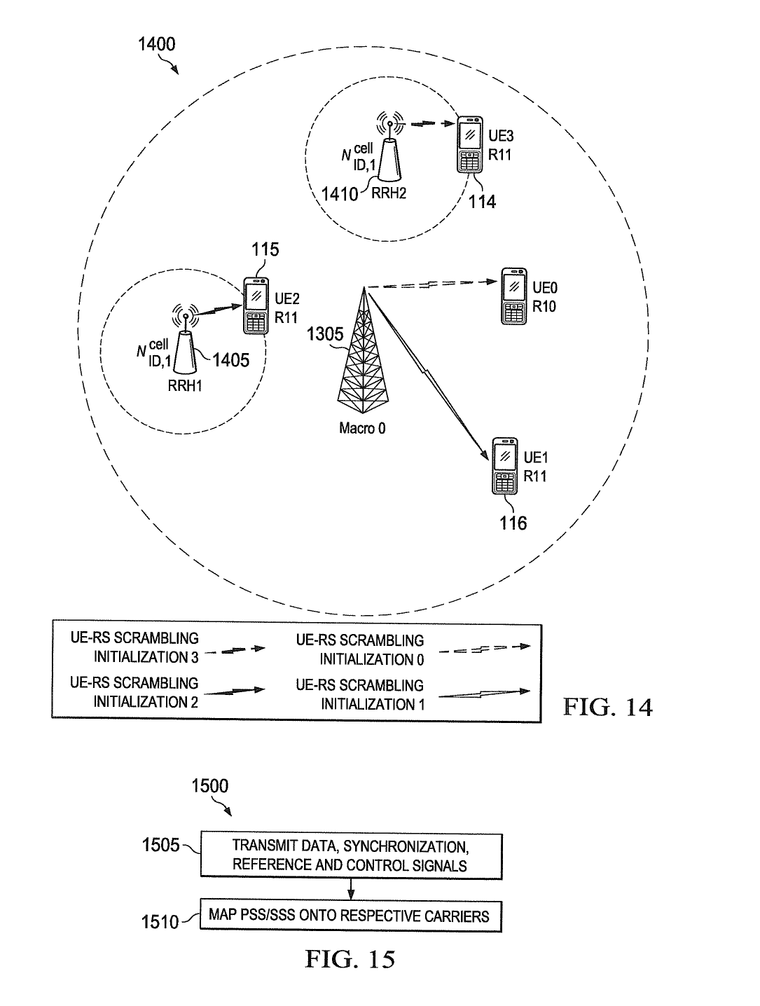

FIG. 15 illustrates a process for mapping synchronization according to embodiments of the present disclosure. In block 1505, a base station transmits data, reference signals, synchronization signals and control elements to at least one of the plurality of subscriber stations. In block 1510, the base station maps primary synchronization signals (PSS) and secondary synchronization signals (SSS) each of a carrier of a first carrier type, such as a Rel-10 compatible carrier, and a carrier of a second carrier type, such as a NCT. The base station maps the PSS and SSS (PSS/SSS) on the second carrier type onto different time locations than in the first carrier type. In addition, the base station maps the PSS and SSS (PSS/SSS) on the second carrier type are mapped onto different time locations than in the first carrier type. The time locations difference comprises at least one of: different OFDM symbols; and different sub-frames. The PSS/SSS are mapped onto consecutive resource elements (REs) on each of the carrier of the first type and the carrier of the second type, wherein subcarrier indices k for the REs are represented by the following:

$$k = n - 31 + \frac{{N}_{RB}^{DL} {N}_{sc}^{RB}}{2} , n = 0 , … , 61$$

where N_{RB}^{DL} represents a total number of physical resource blocks (PRBs) in a respective carrier, and N_{sc}^{RB} is a number of subcarriers per PRB.

In certain embodiments, in block 1510, the PSS on the carrier of the first carrier type is mapped according to:

for frequency division duplex (FDD), and for frame structure type 1, the PSS is mapped to a last OFDM symbol in slots 0 and 10;

for time division duplex (TDD), and for frame structure type 2, the PSS is mapped to a third OFDM symbol in sub-frames 1 and 6;

wherein an SSS sequence is mapped to OFDM symbols 1 represented by the following:

$$1 = \{ \begin{matrix}{N}_{symb}^{DL} - 2 & in slots 0 and 10 & for FDD \\ {N}_{symb}^{DL} - 1 & in slots 1 and 11 & for TDD\end{matrix}$$

wherein N_{symb}^{DL} is the total number of OFDM symbols in a corresponding time slot.

In certain embodiments, in block 1510, the base station maps an SSS sequence d(n) is mapped to resource elements according to:

$${a}_{k , 1} = d ( n ) , \\ n = 0 , … , 61$$

$$k = n - 31 + \frac{{N}_{RB}^{DL} {N}_{sc}^{RB}}{2}$$

$$1 = \{ \begin{matrix}{N}_{symb}^{DL} - 2 & in slots 0 and 10 & for FDD \\ {N}_{symb}^{DL} - 1 & in slots 1 and 11 & for TDD\end{matrix}$$

wherein N_{RB}^{DL} is the total number of PRBs in the carrier, and N_{sc}^{RB} is the number of subcarriers per PRB.

In certain embodiments, the base station maps the PSS and SSS on the carrier of the second carrier type according to:

for FDD, PSS and SSS are located on the OFDM symbols l=2 and l=1 of slots 0 and 10, respectively; and

for TDD, PSS and SSS are located on the OFDM symbols

l=N_{symb}^{DL}−3 and l=N_{symb}^{DL}−6 in slots 2 and 12, respectively.

In certain embodiments, the base station maps the PSS and SSS on the carrier of the second carrier type according to: for FDD and TDD, PSS and SSS are located on the OFDM symbols l=2 and l=1 of slots 0 and 10, respectively.

Although FIG. 15 illustrates examples of methods for mapping synchronization signals, various changes may be made to FIG. 15. For example, while shown as a series of steps, the steps in each figure could overlap, occur in parallel, occur in a different order, or occur any number of times.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communications network, a base station configured to communicate with a plurality of base stations via a backhaul link and configured to communicate with a plurality of subscriber stations, the base station comprising:
a transmit path configured to transmit data, reference signals, synchronization signals and control elements to at least one of the plurality of subscriber stations; and
processing circuitry configured to map primary synchronization signals (PSS) and secondary synchronization signals (SSS) onto each of a carrier of a first carrier type and a carrier of a second carrier type,
wherein the PSS and SSS (PSS/SSS) on the second carrier type are mapped onto different time locations than in the first carrier type, and
wherein the PSS/SSS are mapped onto consecutive resource elements (REs) on each of the carrier of the first type and the carrier of the second type, wherein subcarrier indices k for the REs are represented by the following:
$$k = n - 31 + \frac{{N}_{RB}^{DL} {N}_{sc}^{RB}}{2} , n = 0 , … , 61$$
where N_{RB}^{DL} represents a total number of physical resource blocks (PRBs) in a respective carrier, and N_{sc}^{RB} is a number of subcarriers per PRB.

2. The base station as set forth in claim 1, wherein the time locations difference comprises at least one of: different Orthogonal Frequency Division Multiplex (OFDM) symbols; and different sub-frames.

3. The base station as set forth in claim 1, wherein the first carrier type comprises a Release-10 (Rel-10) compatible carrier and the second carrier type comprises a new carrier type (NCT).

4. The base station as set forth in claim 1, wherein the PSS location on the carrier of the first carrier type is mapped according to:
for frequency division duplex (FDD), and for frame structure type 1, the PSS is mapped to a last OFDM symbol in slots 0 and 10;
for time division duplex (TDD), and for frame structure type 2, the PSS is mapped to a third OFDM symbol in sub-frames 1 and 6; and
wherein an SSS sequence is mapped to OFDM symbols 1 represented by the following:
$$1 = \{ \begin{matrix}{N}_{symb}^{DL} - 2 & in slots 0 and 10 & for FDD \\ {N}_{symb}^{DL} - 1 & in slots 1 and 11 & for TDD\end{matrix}$$
wherein N_{symb}^{DL} is the total number of OFDM symbols in a corresponding time slot.

5. The base station as set forth in claim 1, wherein the PSS and SSS on the carrier of the second carrier type is mapped according to:
for FDD, PSS and SSS are located on OFDM symbols l=2 and l=1 of slots 0 and 10, respectively; and
for TDD, PSS and SSS are located on OFDM symbols l=N_{symb}^{DL}−3 and l=N_{symb}^{DL}−6 in slots 2 and 12, respectively.

6. The base station as set forth in claim 1, wherein the PSS and SSS on the carrier of the second carrier type is mapped according to:
for FDD and TDD, PSS and SSS are located on OFDM symbols l=2 and l=1 of slots 0 and 10, respectively.

7. For use in a wireless communications network, a method for mapping synchronization signals, the method comprising:
transmitting data, reference signals, synchronization signals and control elements to at least one of the plurality of subscriber stations; and
mapping primary synchronization signals (PSS) and secondary synchronization signals (SSS) onto each of a carrier of a first carrier type and a carrier of a second carrier type,
wherein the PSS and SSS (PSS/SSS) on the second carrier type are mapped onto different time locations than in the first carrier type, and
wherein the PSS/SSS are mapped onto consecutive resource elements (REs) on each of the carrier of the first carrier type and the carrier of the second carrier type, wherein the subcarrier indices k for the REs are represented by the following:
$$k = n - 31 + \frac{{N}_{RB}^{DL} {N}_{sc}^{RB}}{2} , n = 0 , … , 61$$
where N_{RB}^{DL} represents a total number of physical resource blocks (PRBs) in a respective carrier, and N_{sc}^{RB} in is a number of subcarriers per PRB.

8. The method as set forth in claim 7, wherein the time locations difference comprises at least one of: different Orthogonal Frequency Division Multiplex (OFDM) symbols; and different sub-frames.

9. The method as set forth in claim 7, wherein the first carrier type comprises a Release-10 (Rel-10) compatible carrier and the second carrier type comprises a new carrier type (NCT).

10. The method as set forth in claim 7, wherein mapping comprises mapping the PSS on the carrier of the first carrier type according to:
for frequency division duplex (FDD), and for frame structure type 1, mapping the PSS to a last OFDM symbol in slots 0 and 10;
for time division duplex (TDD), and for frame structure type 2, mapping the PSS to a third OFDM symbol in sub-frames 1 and 6; and
wherein an SSS sequence is mapped to OFDM symbols 1 represented by the following:
$$1 = \{ \begin{matrix}{N}_{symb}^{DL} - 2 & in slots 0 and 10 & for FDD \\ {N}_{symb}^{DL} - 1 & in slots 1 and 11 & for TDD\end{matrix}$$
where N_{symb}^{DL} is a total number of OFDM symbols in a corresponding time slot.

11. The method as set forth in claim 7, wherein mapping comprises mapping the PSS and SSS on the carrier of the second carrier type according to:
for FDD, PSS and SSS are located on OFDM symbols l=2 and l=1 of slots 0 and 10, respectively.

12. The method as set forth in claim 7, wherein mapping comprises mapping the PSS and SSS on the carrier of the second carrier type according to:
for TDD, PSS and SSS are located on OFDM symbols l=N_{symb}^{DL}−3 and l=N_{symb}^{DL}−6 in slots 2 and 12, respectively.

13. The method as set forth in claim 7, wherein mapping comprises mapping the PSS and SSS on the carrier of the second carrier type according to:
for FDD and TDD, PSS and SSS are located on OFDM symbols l=2 and l=1 of slots 0 and 10, respectively.

14. For use in a wireless communications network, a subscriber station configured to communicate with at least one base station, wherein the base station is configured to communicate with a plurality of base stations via a backhaul link, the subscriber station comprising:
a receiver configured to receive data, reference signals, synchronization signals and control elements from the base station; and
processing circuitry configured to read primary synchronization signals (PSS) and secondary synchronization signals (SSS) mapped onto each of a carrier of a first carrier type and a carrier of a second carrier type,
wherein the PSS and SSS (PSS/SSS) on the second carrier type are mapped onto different time locations than in the first carrier type, and
wherein the PSS/SSS are mapped onto consecutive resource elements (REs)
on each of the carrier of the first carrier type and the carrier of the second carrier type, wherein the subcarrier indices k for the REs are represented by the following:
$$k = n - 31 + \frac{{N}_{RB}^{DL} {N}_{sc}^{RB}}{2} , n = 0 , … , 61$$
where N_{RB}^{DL} represents a total number of physical resource blocks (PRBs) in a respective carrier, and N_{sc}^{RB} is a number of subcarriers per PRB.

15. The subscriber station as set forth in claim 14, wherein the time locations difference comprises at least one of: different Orthogonal Frequency Division Multiplex (OFDM) symbols; and different sub-frames.

16. The subscriber station as set forth in claim 14, wherein the first carrier type comprises a Release-10 (Rel-10) compatible carrier and the second carrier type comprises a new carrier type (NCT).

17. The subscriber station as set forth in claim 14, wherein the PSS location on the carrier of the first carrier type is mapped according to:
for frequency division duplex (FDD), and for frame structure type 1, the PSS is mapped to a last OFDM symbol in slots 0 and 10;
for time division duplex (TDD), and for frame structure type 2, the PSS is mapped to a third OFDM symbol in sub-frames 1 and 6; and
wherein an SSS sequence is mapped to OFDM symbols 1 represented by the following:
$$1 = \{ \begin{matrix}{N}_{symb}^{DL} - 2 & in slots 0 and 10 & for FDD \\ {N}_{symb}^{DL} - 1 & in slots 1 and 11 & for TDD\end{matrix}$$
where N_{symb}^{DL} is a total number of OFDM symbols in a corresponding time slot.

18. The subscriber station as set forth in claim 14, wherein the PSS and SSS on the carrier of the second carrier type is mapped according to:
for FDD, PSS and SSS are located on OFDM symbols l=2 and l=1 of slots 0 and 10, respectively.

19. The subscriber station as set forth in claim 14, wherein the PSS and SSS on the carrier of the second carrier type is mapped according to:
for TDD, PSS and SSS are located on OFDM symbols l=N_{symb}^{DL}−3 and l=N_{symb}^{DL}−6 in slots 2 and 12, respectively.

20. The subscriber station as set forth in claim 14, wherein the PSS and SSS on the carrier of the second carrier type is mapped according to:
for FDD and TDD, PSS and SSS are located on OFDM symbols l=2 and l=1 of slots 0 and 10, respectively.
